(19) United States
(12) Patent Application Publication
(10) Pub. No.: US 2026/0239326 A1
(43) Pub. Date: Aug. 13, 2026

(54) RELAY APPARATUS AND COMMUNICATION CONTROL METHOD

(71) Applicant: NTT DOCOMO, INC., Tokyo (JP)

(72) Inventors: Daisuke KURITA, Tokyo (JP); Hiroki HARADA, Tokyo (JP); Weiqi SUN, Beijing (CN); Jing WANG, Beijing (CN); Lan CHEN, Beijing (CN)

(73) Assignee: NTT DOCOMO, INC., Tokyo (JP)

(21) Appl. No.: 19/155,602

(22) PCT Filed: Feb. 21, 2023
(86) PCT No.: PCT/JP2023/006312

§ 371 Date: Aug. 12, 2025

(51) Int. Cl. H04W 72/044; H04W 72/20; H04W 80/02

(52) U.S. Cl. CPC H04W 72/046; H04W 72/20; H04W 80/02

(57) ABSTRACT

A relay device according to one aspect of the present disclosure comprises: a reception unit which receives, from a base station, control information regarding a beam used by the relay device on a communication link for relaying, between the base station and the relay device, communication between the base station and a terminal; and a control unit which determines, on the basis of the control information, the beam used by the relay device. The control information includes one or both of first beam information regarding a first beam used for signal reception from the base station on the communication link and second beam information regarding a second beam used for signal transmission to the base station on the communication link.

### TECHNICAL FIELD

The present disclosure relates to a relay apparatus and a communication control method.

### BACKGROUND ART

The 3rd Generation Partnership Project (3GPP (registered trademark)) has specified a 5th generation mobile communication system (5G), also referred to as New Radio (NR) or Next Generation (NG), and is also specifying a next-generation system called Beyond 5G, 5G Evolution, or 6G.

In NR, a communication apparatus (which may be referred to as a relay apparatus) that relays a signal between a user equipment (UE) (which may be simply referred to as a terminal) and a radio base station (which may be simply referred to as a base station) has been under study (see, e.g., Non-Patent Literature (hereinafter, referred to as NPL) 1).

### CITATION LIST

### Non-Patent Literature

### NPL 1

“Discussion on operation scenarios for NCR”, R1-2204534, 3GPP TSG RAN WG1 #109-e, 3GPP, May 2022.

### SUMMARY OF INVENTION

However, in the relay apparatus, control based on an indication for an operation related to communication has not been sufficiently studied, and in a case where specifications regarding such control are not clarified, there is a concern that the relaying of a signal cannot be appropriately performed.

An aspect of the present disclosure provides a relay apparatus and a communication control method each capable of appropriately relaying a signal based on an indication for an operation related to communication.

A communication method according to an aspect of the present disclosure includes: a reception section that receives, from a base station, control information related to a beam to be used by the relay apparatus in a communication link for relaying, between the base station and the relay apparatus, communication between the base station and a terminal; and a control section that determines the beam to be used by the relay apparatus, based on the control information, in which the control information includes one or both of first beam information related to a first beam to be used for receiving a signal from the base station in the communication link, and second beam information related to a second beam to be used for transmitting a signal to the base station in the communication link.

### BRIEF DESCRIPTION OF DRAWINGS

FIG. 1 illustrates an exemplary radio communication system according to an embodiment of the present disclosure;

FIG. 2 illustrates exemplary frequency ranges used in a radio communication system according to an embodiment of the present disclosure;

FIG. 3 illustrates configuration examples of a radio frame, a subframe, and a slot used in a radio communication system according to an embodiment of the present disclosure;

FIG. 4 illustrates a configuration example of an NCR;

FIG. 5A illustrates a configuration example of a MAC CE;

FIG. 5B illustrates another configuration example of the MAC CE;

FIG. 5C illustrates still another configuration example of the MAC CE;

FIG. 5D illustrates still another configuration example of the MAC CE;

FIG. 5E illustrates still another configuration example of the MAC CE;

FIG. 5F illustrates still another configuration example of the MAC CE;

FIG. 6A illustrates still another configuration example of the MAC CE;

FIG. 6B illustrates still another configuration example of the MAC CE;

FIG. 6C illustrates still another configuration example of the MAC CE;

FIG. 6D illustrates still another configuration example of the MAC CE;

FIG. 6E illustrates still another configuration example of the MAC CE;

FIG. 6F illustrates still another configuration example of the MAC CE;

FIG. 7A illustrates still another configuration example of the MAC CE;

FIG. 7B illustrates still another configuration example of the MAC CE;

FIG. 8A illustrates still another configuration example of the MAC CE;

FIG. 8B illustrates still another configuration example of the MAC CE;

FIG. 8C illustrates still another configuration example of the MAC CE;

FIG. 8D illustrates still another configuration example of the MAC CE;

FIG. 8E illustrates still another configuration example of the MAC CE;

FIG. 9 is a flowchart illustrating an operation example of a relay apparatus according embodiment of the present disclosure;

FIG. 10 is a block diagram illustrating an exemplary configuration of a base station according to an embodiment of the present disclosure;

FIG. 11 is a block diagram illustrating an exemplary configuration of a terminal according to an embodiment of the present disclosure;

FIG. 12 is a block diagram illustrating an exemplary configuration of the relay apparatus according to an embodiment of the present disclosure;

FIG. 13 illustrates an exemplary hardware configuration of the base station, the relay apparatus, and the terminal according to an embodiment of the present disclosure; and

FIG. 14 illustrates an exemplary configuration of a vehicle.

### DESCRIPTION OF EMBODIMENTS

Hereinafter, an embodiment of the present disclosure will be described with reference to the drawings. Note that the embodiment described below is merely an example, and the embodiment to which the present disclosure is applied is not limited to the following embodiment.

In operations of a radio communication system according to the embodiments of the present disclosure, an existing technique is used as appropriate. The existing technique is, for example, existing LTE or existing NR, but is not limited to the existing LTE and NR.

In addition, in the embodiment of the present disclosure described below, terms such as a synchronization signal (SS), a primary SS (PSS), a secondary SS (SSS), a physical broadcast channel (PBCH), a physical random access channel (PRACH), a physical downlink control channel (PDCCH), a physical downlink shared channel (PDSCH), a physical uplink control channel (PUCCH), and a physical uplink shared channel (PUSCH), used in the existing LTE or existing NR, are used. This is for the sake of convenience in description, and the same signals, functions, and the like may be referred to by other names. In addition, the above-described terms in NR correspond to a NR-SS, NR-PSS, NR-SSS, NR-PBCH, NR-PRACH, and the like. However, even in a case where a signal is used in NR, it is not necessarily referred to as “NR-.”

Further, in the embodiment of the present disclosure, the duplex method may be a Time Division Duplex (TDD) method, a Frequency Division Duplex (FDD) method, or another method (e.g., Flexible Duplex method).

Further, in the embodiment of the present disclosure, the phrase “a radio parameter or the like is ‘configured’” may mean that a given value is pre-configured or that a radio parameter that is indicated from a base station or a terminal is configured.

### Embodiment

### Radio Communication System

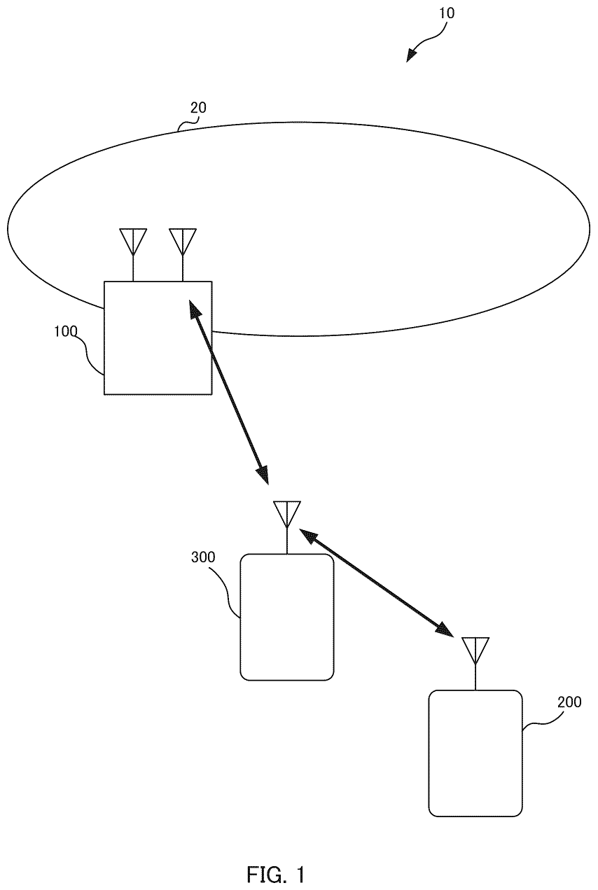

FIG. 1 is a diagram illustrating exemplary radio communication system 10 according to an embodiment of the present disclosure. Radio communication system 10 is a radio communication system in accordance with 5G NR, and includes Next Generation-Radio Access Network 20 (hereinafter, referred to as NG-RAN 20) and terminal 200 (hereinafter, also referred to as user equipment (UE) 200).

Note that radio communication system 10 may be a radio communication system in accordance with a method called Beyond 5G, 5G Evolution, or 6G.

NG-RAN 20 includes base station 100 (hereinafter also referred to as gNB 100). Note that the number of gNBs and the number of UEs are not limited to the examples illustrated in FIG. 1.

NG-RAN 20 actually includes a plurality of NG-RAN nodes, specifically, gNBs (or ng-eNBs), and is connected to a core network (5GC, not illustrated) in accordance with 5G. Note that NG-RAN 20 and 5GC may be simply referred to as “network.” Further, in the following, gNB may be read as a network (NW).

For example, gNB 100 is a base station in accordance with 5G, and performs radio communication with UE 200 in accordance with 5G. Further, in the example illustrated in FIG. 1, relay apparatus 300 that relays signals is illustrated between gNB 100 and UE 200. Relay apparatus 300 performs a relay operation of, for example, transmitting a signal received from gNB 100 to UE 200 and transmitting a signal received from UE 200 to gNB 100. Note that the term “relaying” may be replaced with the term “forwarding.” Further, the term “operation” may be replaced with the term “processing,” “control,” or the like. Relay apparatus 300 that has been studied in NR will be described in detail later.

gNB 100 and UE 200 may support: Multiple-Input Multiple-Output (MIMO) for generating a beam with higher directivity by controlling radio signals transmitted from a plurality of antenna elements; carrier aggregation (CA) for bundling a plurality of component carriers (CCs); and dual connectivity (DC) for enabling communication between a UE and each of two NG-RAN nodes.

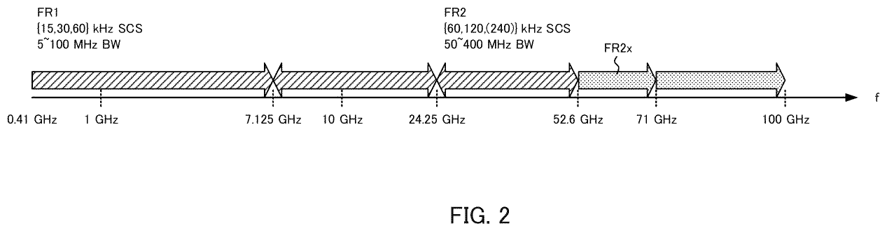

Further, radio communication system 10 may support a plurality of frequency ranges (FRs). FIG. 2 illustrates examples of FRs used in radio communication system 10. As illustrated in FIG. 2, radio communication system 10 may support FR1 and FR2. The frequency band of each FR is, for example, as follows:
FR1: 410 MHz to 7.125 GHZ
FR2: 24.25 GHz to 52.6 GHZ

In FR1, a sub-carrier spacing (SCS) of 15 kHz, 30 kHz, or 60 kHz may be used, and a bandwidth (BW) of 5 to 100 MHz may be used. FR2 is a higher frequency than FR1, and an SCS of 60 kHz or 120 kHz (240 kHz may be included) is used, and a bandwidth (BW) of 50 to 400 MHz may be used.

Note that SCS may be interpreted as numerology. Numerology is defined in 3GPP TS 38.300 and corresponds to one subcarrier spacing in the frequency domain.

Further, radio communication system 10 may support a frequency band higher than the frequency band of FR2. Specifically, radio communication system 10 may support a frequency band exceeding 52.6 GHz and up to 114.25 GHZ. Such a high frequency band may be referred to as “FR2x” for convenience. In a case where a band exceeding 52.6 GHz is used, Cyclic Prefix-Orthogonal Frequency Division Multiplexing (CP-OFDM)/ Discrete Fourier Transform-Spread-Orthogonal Frequency Division Multiplexing (DFT-S-OFDM) with a larger SCS may be applied.

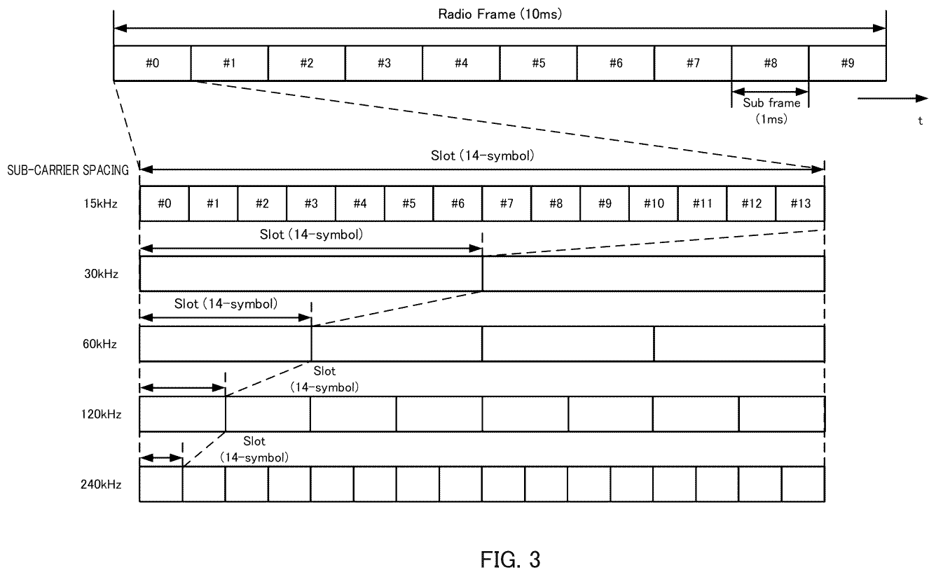

FIG. 3 is a diagram illustrating an exemplary configuration of a radio frame (system frame), a subframe, and a slot used in radio communication system 10. As illustrated in FIG. 3, one slot is configured with 14 symbols, and the symbol duration (and the slot duration) becomes shorter as the SCS becomes larger (wider). Note that the SCS is not limited to the durations (frequencies) illustrated in FIG. 3. For example, 480 kHz, 960 kHz, or the like may be used as the SCS.

Further, the number of symbols constituting one slot is not necessarily 14 symbols (e.g., the number of symbols may be 28 or 56 symbols). Further, the number of slots per subframe may vary depending on the SCS.

Note that the time direction (t) illustrated in FIG. 3 may be referred to as a time domain, a symbol period, a symbol time, or the like. Further, the frequency direction may be referred to as a frequency domain, a resource block, a subcarrier, a bandwidth part (BWP), or the like.

As a downlink (DL) signal, gNB 100 transmits control information, configuration information, and the like of gNB 100 to UE 200.

Furthermore, for example, gNB 100 receives, as an uplink (UL) signal, control information, a data signal, information related to the processing capability of UE 200 (terminal capability (information); e.g., UE capability), and the like from UE 200.

Relay apparatus 300 performs a forwarding operation of forwarding the DL signal to UE 200. Further, relay apparatus 300 performs a forwarding operation of forwarding the UL signal to gNB 100. Note that, in the following, the UL signal received by gNB 100 from UE 200 and/or the DL signal received by UE 200 from gNB 100 may be a signal relayed by relay apparatus 300.

UE 200 is a communication apparatus with a radio communication function, such as a smartphone, a mobile phone, a tablet, a wearable terminal, or a communication module for Machine-to-Machine (M2M).

UE 200 receives a control signal or a data signal from gNB 100 in DL and transmits a control signal or a data signal to gNB 100 in UL, thereby utilizing various communication services provided by radio communication system 10. Further, UE 200 receives various reference signals transmitted from gNB 100 and performs measurement of the propagation path quality based on the reception results of the reference signals.

The channels used for DL signal transmission include, for example, data channels and control channels. For example, the data channels may include a Physical Downlink Shared Channel (PDSCH), and the control channels may include a Physical Downlink Control Channel (PDCCH). For example, gNB 100 transmits control information to UE 200 using a PDCCH and transmits a DL data signal using a PDSCH. Note that a PDSCH is an example of a downlink shared channel, and a PDCCH is an example of a downlink control channel. Note that the PDCCH may be read as downlink control information (DCI), control information, or the like transmitted on the PDCCH.

The reference signal included in the DL signal may include, for example, at least one of a demodulation reference signal (DMRS), a phase tracking reference signal (PTRS), a channel state information-reference signal (CSI-RS), a sounding reference signal (SRS), and a positioning reference signal (PRS). For example, reference signals such as DMRS and PTRS are used for demodulation of DL data signals and are transmitted using a PDSCH.

The channels used for UL signal transmission include, for example, data channels and control channels. For example, the data channels may include a Physical Uplink Shared Channel (PUSCH), and the control channels may include a Physical Uplink Control Channel (PUCCH). For example, UE 200 transmits control information using a PUCCH and transmits a UL data signal using a PUSCH. Note that a PUSCH is an example of an uplink shared channel, and a PUCCH is an example of an uplink control channel. The shared channel may also be referred to as a data channel. Note that the PUSCH or PUCCH may be read as uplink control information (UCI), control information, or the like transmitted on the PUSCH or PUCCH.

The reference signal included in the UL signal may include, for example, at least one of a DMRS, a PTRS, a CSI-RS, an SRS, and a PRS for positional information. For example, reference signals such as a DMRS and a PTRS are used for demodulation of UL data signals and are transmitted using a PUSCH.

### Relay Apparatus

In Release 18 (Rel-18) of 3GPP, a new study item on an NR Network-controlled Repeater has been studied. Hereinafter, the NR Network-controlled Repeater is abbreviated as NCR. The NCR may correspond to, for example, relay apparatus 300 in FIG. 1. Hereinafter, relay apparatus 300 is sometimes referred to as NCR 300. The term NCR may be replaced with a term such as a repeater, a forwarding apparatus, a communication apparatus, or the like.

In the NCR, unlike a conventional amplify and forward repeater, at least one of the control of the timing of transmission, the control of the timing of reception, the control of whether to perform a DL operation or a UL operation (e.g., switching), and the control of turning ON and OFF the operation of the NCR may be executed. Further, power control may be performed in the NCR. In addition, the NCR can control directivity in the transmission operation and/or the reception operation. That is, in the NCR, a beam to be transmitted and/or a beam to be received may be controlled.

In the policy of a work item (WI) of an NCR in Rel-18, focus is placed on the following scenario and assumption in accordance with the recommendation defined in TR 38.867. Note that an NCR may be referred to as an NR NCR.

An NCR is an inband radio frequency (RF) repeater used to extend the network coverage in the bands of FR1 and FR2 based on the NCR model in TR38.867.

The NCR is a single-hop fixed-type apparatus dedicated to the NCR.

The NCR is transparent to UEs.

Further, the NCR may simultaneously maintain a link between a gNB and the NCR (which may be referred to as “gNB-repeater link”) and a link between the NCR and a UE (which may be referred to as “repeater-UE link”).

In view of the above points, an NCR may support the following points.
Signaling of side control information and operation designation for controlling NCR-Fwd (described later).

Note that the side control information includes, for example, at least one of information related to beamforming, information related to UL-DL operation, information related to ON/OFF, and information related to power control. The perspective of the power control has been discussed in a meeting of 3GPP. The side control information may be simply referred to as control information.
Specification of control plane signaling and procedures.

For example, a configuration of signaling for indication of the side control information may be supported. In addition, down-selection of a solution in Section 7.2 of TR 38.867 may be required.

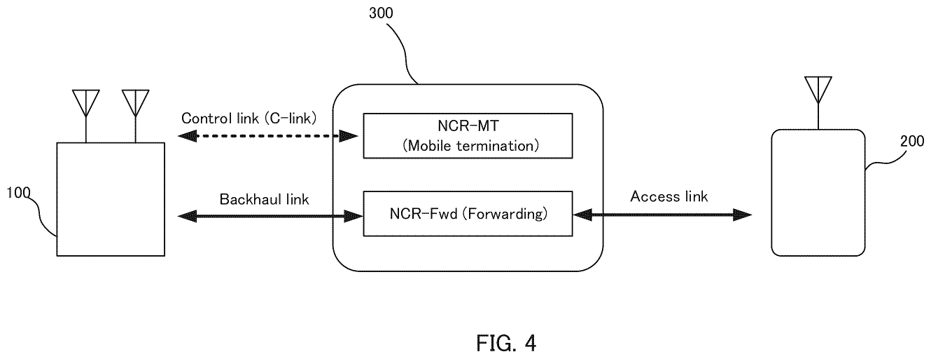

FIG. 4 illustrates a configuration example of NCR 300. NCR 300 is present between UE 200 and gNB 100. NCR 300 may or need not be present between UE 200 and gNB 100 in the real space.

NCR 300 receives a UL signal transmitted from UE 200 and addressed to gNB 100, and transmits the UL signal to the destination of gNB 100. In other words, NCR 300 forwards the UL signal transmitted from UE 200 and addressed to gNB 100 to the destination of gNB 100. Furthermore, NCR 300 receives a DL signal transmitted from gNB 100 and addressed to UE 200, and transmits the DL signal to the destination of UE 200. In other words, NCR 300 forwards the signal transmitted from gNB 100 and addressed to UE 200 to the destination of UE 200.

In addition, NCR 300 may operate based on control information (e.g., side control information) received from gNB 100.

As illustrated in FIG. 4, a link between NCR 300 and UE 200 may be referred to as an access link. Furthermore, as illustrated in FIG. 4, two links are present between NCR 300 and gNB 100. Between the two links, a link through which a signal received from UE 200 and addressed to gNB 100 is transmitted may be referred to as a backhaul link. In the backhaul link, NCR 300 may receive a signal addressed to UE 200 from gNB 100. Between the two links, a link through which information is exchanged between gNB 100 and NCR 300 may be referred to as a control link (hereinafter, sometimes referred to as C-link). For example, side control information may be exchanged in the control link.

In FIG. 4, an example is illustrated in which gNB 100 included in the C-link and gNB 100 included in the backhaul link are the same, but gNB 100 included in the C-link and gNB 100 included in the backhaul link may be different from each other.

Furthermore, the frequency (e.g., carrier or frequency band) used for communication in the C-link, the frequency used for communication in the backhaul link, and the frequency used for communication in the access link are not particularly limited. These three frequencies may be the same as one another, or at least two of the three frequencies may be different from each other. Alternatively, one of the three frequencies may include another one of the frequencies.

In addition, in each of the three links of the C-link, the backhaul link, and the access link, a link in a direction toward gNB 100 may be referred to as an uplink (UL), and a link in a direction opposite to the UL may be referred to as a downlink (DL). In this case, the frequency used for communication in the UL and the frequency used for communication in the DL in each of the three links may be the same as or different from each other.

NCR 300 illustrated in FIG. 4 includes two functional entities referred to as NCR-MT and NCR-Fwd. The NCR-MT and the NCR-Fwd may be each referred to by a different term (e.g., NCR_MT and NCR_Fwd). In the following description, the NCR-MT may be simply referred to as MT, and the NCR-Fwd may be simply referred to as Fwd.

The NCR-MT is a functional entity that communicates with gNB 100 via the control link (C-link) to enable information exchange with gNB 100. The information exchange with gNB 100 may be, for example, transmission and reception of side control information. In addition, the control link may be based on a Uu interface of NR. The NCR-MT may be regarded as equivalent to a UE.

An indication related to communication control for the backhaul link may be identified (specified or provided) by the side control information. For example, a beam indication for the backhaul link may be identified (specified or provided) by the side control information.

The beam indication corresponds to an indication for the NCR to perform beam control. The beam indication is performed, for example, from the gNB to the NCR. The beam indication may include an indication of a beam to be used by the NCR, information related to a resource (e.g., time resource (may be referred to as a time domain resource)) to be used by the NCR for the beam, or the like. The information related to the time resource may be simply referred to as a time resource as appropriate. The beam indication may include an indication other than the above-described indication, or need not include a part of the above-described indication.

Note that the “indication” of a certain function (or operation) may refer to information for performing the function (or operation), or may refer to an operation such as transmission (or notification) of information for performing the function (or operation). Note that the term “indication” may be replaced with a term such as an indicator, information, parameter, or the like. For example, the beam indication may refer to information for performing beam control, or may refer to an operation such as transmission (or notification) of information for performing beam control.

Note that, in the NCR-MT, the side control information may include at least information for controlling the NCR-Fwd. In addition, the side control information may be notified by signaling of at least one of Radio Resource Control (RRC), Medium Access Control Control Element (MAC CE), or Downlink Control Information (DCI).

The NCR-Fwd is a functional entity that forwards signals between a gNB and the NCR-Fwd and between a UE and the NCR-Fwd via the backhaul link and the access link, respectively. For example, the NCR-Fwd amplifies and forwards a radio frequency (RF) signal of UL, and amplifies and forwards an RF signal of DL. The operation of the NCR-Fwd may be controlled in accordance with the side control information received from the gNB.

In the embodiment of the present disclosure, NCR 300 may have a function of reflecting signals transmitted from base station 100 or terminal 200. For example, the reflective function may be a function related to phase change or a function related to beam control (e.g., Transmission Configuration Indication state (TCI state), function related to control of Quasi-Colocation (QCL), selection and application of a beam, and/or selection and application of a spatial filter/precoding weight).

Here, the TCI state is information related to QCL of a signal/channel, and may be referred to as a spatial reception parameter, spatial relation information, or the like. The TCI state may be configured to NCR 300 and/or terminal 200. For example, the TCI state may be configured to NCR 300 and/or terminal 200 for each channel or for each signal.

QCL is an indicator indicating the statistical properties of a signal/channel. For example, when a certain signal/channel and another signal/channel are in a QCL relationship, it may mean that, between the plurality of different signals/channels, at least one of the Doppler shift, Doppler spread, average delay, delay spread, or spatial parameter (e.g., spatial Rx parameter) is the same (QCL for at least one of them).

In the present disclosure, the beam may correspond to QCL information, a spatial relation, a spatial domain parameter, a spatial domain filter, a TCI state, a reference signal (RS) resource index, and an SRS resource indicator (SRI). The terms such the beam, the QCL information, the spatial relation, the spatial domain parameter, the spatial domain filter, the TCI state, the RS resource index, and the SRI may be construed as synonymous or similar, and may be replaced with one another.

In a meeting of 3GPP, at least the following point was agreed upon regarding a beam indication for a backhaul (BH) link related to the NCR-Fwd illustrated in FIG. 4 (also referred to as a backhaul link beam indication). In the present specification, a beam for the backhaul link may be referred to as a backhaul link beam or a backhaul beam.

The backhaul link beam of the NCR may be indicated by a MAC CE.

In a case where a beam indication framework of Release 15 of 3GPP (sometimes abbreviated as Rel-15) (Rel-15 beam indication framework) is used for the NCR-MT, a DL backhaul beam is indicated by a MAC CE using a TCI state ID from a list of beams for the C-link (also referred to as C-link beams) configured by RRC, and a UL backhaul beam is indicated by the MAC CE using an SRI of the C-link. In the Rel-15 beam indication framework, the TCI state or the spatial relation is specified for each channel.

In a case where a beam indication framework of Release 17 of 3GPP (sometimes abbreviated as Rel-17) (Rel-17 beam indication framework; unified TCI) is used for the NCR-MT, a DL backhaul beam is indicated by a MAC CE using a TCI state ID from a list of C-link beams configured by RRC, and a UL backhaul beam is indicated by the MAC CE using a TCI state ID from the list of C-link beams configured by RRC. In the Rel-17 beam indication framework, a common beam may be indicated, and the common beam may be applied to all UL and DL channels, or a common beam for UL may be applied to all UL channels, and a common beam for DL may be applied to all DL channels.

In addition, in Rel-18, it was agreed that the NCR-MT may have a plurality of carriers/serving cells (CA) and the NCR-Fwd may operate in a plurality of carriers/cells.

### Consideration

In a case where the backhaul link beam of the NCR is indicated by a MAC CE, the DL backhaul link beam is indicated by the MAC CE by indicating the TCI state of the C-link of the NCR-MT, and the UL backhaul link beam is indicated by the MAC CE by indicating the TCI state or the SRI of the C-link of the NCR-MT, and in a case where the NCR-MT (C-link) operates in a plurality of carriers/serving cells/BWPs, it is necessary to clarify to which serving cell/BWP of the C-link the indicated TCI state/SRI of the C-link of the NCR-MT correspond. In a case where this is not clarified, there is a concern that an appropriate beam is not selected, a throughput or a quality of communication between the base station and the NCR deteriorates, and the signal cannot be appropriately relayed (problem 1).

In addition, in a case where the beam of the NCR backhaul link is indicated by the MAC CE, the DL backhaul link beam is indicated by the MAC CE by indicating the TCI state of the C-link of the NCR-MT, and the UL backhaul beam is indicated by the MAC CE by indicating the TCI state or the SRI of the C-link of the NCR-MT, it is necessary to clarify a configuration of the MAC CE, that is, content included in the MAC CE. As described above, both the Rel-15 beam indication framework and the Rel-17 beam indication framework can be used for the NCR-MT, but operations related to beam control are different between a case where the Rel-15 beam indication framework is used and a case where the Rel-17 beam indication framework is used. Thus, there is a concern that the operation of the NCR is adversely affected, and the signal cannot be appropriately relayed, unless the configuration of the MAC CE used for the backhaul link beam indication is clarified (problem 2).

Therefore, in the following, proposals regarding the specification of the backhaul link beam indication of the NCR will be described in relation to the above-described problems.

In the present disclosure, the beam indication may be referred to as (control) information related to a beam, or the like. In addition, in the present disclosure, a TCI state (ID), an SRI, a beam index, and the like may be referred to as (control) information related to a beam, beam information, information corresponding to a beam, information for identifying or identifying a beam, or the like.

In the above and the following description, the notation “/” may mean “and/or” unless otherwise specified.

### Proposal 1

In relation to the problem 1, a capability of an NCR related to CA and a BWP will be described.

[Option 1]

As the capability of an NCR-MT related to CA, the following Options 1-1 to 1-3 can be considered.

### Option 1-1

By default, the NCR-MT of Rel-18 does not support CA. One NCR-MT may operate only in one serving cell (may be configured to have only one serving cell or only one serving cell may be configured).

### Option 1-2

By default, the NCR-MT of Rel-18 supports CA. One NCR-MT may be configured to operate in a plurality of serving cells (may be configured to have a plurality of serving cells or a plurality of serving cells may be configured).

### Option 1-3

Whether the NCR-MT of Rel-18 supports CA is an optional NCR function, and may be reported by RRC or operations and maintenance (OAM).

### [Option 2]

As the capability of an NCR-MT related to a BWP, the following Options 2-1 to 2-3 can be considered.

### Option 2-1

By default, the NCR-MT of Rel-18 does not support a configuration with a plurality of BWPs in a serving cell (does not support a plurality of BWPs being configured in a serving cell).

### Option 2-2

By default, the NCR-MT of Rel-18 may be configured to have a plurality of BWPs in a serving cell (a plurality of BWPs may be configured in a serving cell).

### Option 2-3

Whether the NCR-MT of Rel-18 may be configured to have a plurality of BWPs in a serving cell (whether a plurality of BWPs may be configured in a serving cell) is an optional NCR function, and may be reported by RRC or OAM.

### Proposal 2

In relation to the problem 1, in a case where the backhaul link beam of the NCR is indicated by a MAC CE, the DL backhaul link beam is indicated by the MAC CE by indicating the TCI state of the C-link of the NCR-MT, and the UL backhaul beam is indicated by the MAC CE by indicating the TCI state or the SRI of the C-link, and as described in Proposal 1, in a case where the NCR-MT is configured to have a plurality of serving cells or is configured to have a plurality of BWPs in a serving cell, the indicated TCI state/SRI of the C-link may be based on following Option 1 or 2.

### [Option 1]

In a case where the NCR-MT is configured to have a plurality of serving cells, the indicated TCI state/SRI of the NCR-MT C-link may be the TCI state/SRI of a specific serving cell of the NCR-MT.

### Option 1-1

The indicated TCI state/SRI of the NCR-MT C-link may be, for example, the TCI state/SRI of a specific serving cell of the NCR-MT that is selected, determined, or configured based on specific conditions/rules as follows:
The specific serving cell is a primary cell (PCell) of the NCR-MT.
The specific serving cell is a serving cell of the NCR-MT having the highest/lowest cell index.
In a case where the band of the carrier/cell of the NCR-Fwd backhaul link is the same as the band of the carrier/serving cell of the NCR-MT, the specific serving cell is the serving cell.
In a case where the bandwidth of the carrier/cell of the NCR-Fwd backhaul link is the same as the bandwidth of the carrier/serving cell of the NCR-MT, the specific serving cell is the serving cell.
In a case where the center frequency of the carrier/cell of the NCR-Fwd backhaul link is the same as the center frequency of the carrier/serving cell of the NCR-MT, the specific serving cell is the serving cell.
In a case where the bandwidth of the carrier/cell of the NCR-Fwd backhaul link is within the bandwidth of the carrier/serving cell of the NCR-MT, the specific serving cell is the serving cell.
In a case where the bandwidth of the carrier/serving cell of the NCR-MT is within the bandwidth of the carrier/cell of the NCR-Fwd backhaul link, the specific serving cell is the serving cell.
In a case where the bandwidth of the carrier/cell of the NCR-Fwd backhaul link overlaps with the bandwidth of the carrier/serving cell of the NCR-MT, the specific serving cell is the serving cell.
In a case where a plurality of serving cells of the NCR-MT satisfies the above-described condition, one serving cell of the NCR-MT is selected, determined, or configured according to a further rule. For example, in a case where the PCell of the NCR-MT satisfies the condition, the PCell of the NCR-MT is selected, determined, or configured, the serving cell of the NCR-MT having the highest/lowest cell index is selected, determined, or configured, or the like.

In Option 1-1, NCR 300 (NCR-MT and/or NCR-Fwd) may select, determine, or configure a specific serving cell corresponding to the indicated TCI state/SRI based on the specific condition/rule as described above.

### Option 1-2

The indicated TCI state/SRI of the NCR-MT C-link may be, for example, the TCI state/SRI of a specific serving cell of the NCR-MT that is (e.g., explicitly) configured by the network through side control information via RRC/MAC CE/DCI. For example, the specific serving cell (e.g., serving cell ID) may be included in the MAC CE (e.g., MAC CE described later) that carries an NCR backhaul link beam indication.

In Option 1-2, NCR 300 (NCR-MT and/or NCR-Fwd) may receive information (e.g., serving cell ID) related to a specific serving cell of the NCR-MT from base station 100 through RRC/MAC CE/DCI, and select, determine, or configure the specific serving cell corresponding to the indicated TCI state/SRI based on the information.

### [Option 2]

In a case where the NCR-MT is configured to have a plurality of DL BWPs/UL BWPs in a serving cell, the indicated TCI state/SRI of the NCR-MT C-link may be the TCI state/SRI of the BWP of the NCR-MT.

### Option 2-1

The indicated TCI state/SRI of the NCR-MT C-link may be, for example, the TCI state/SRI of a specific BWP of the NCR-MT that is selected, determined, or configured based on specific conditions/rules as follows:
The specific BWP is an active DL/UL BWP of the NCR-MT.
The specific BWP is a DL/UL BWP of the NCR-MT having the highest/lowest BWP index.

In Option 2-1, NCR 300 (NCR-MT and/or NCR-Fwd) may select, determine, or configure a specific BWP corresponding to the indicated TCI state/SRI based on the specific condition/rule as described above.

### Option 2-2

The indicated TCI state/SRI of the NCR-MT C-link may be, for example, the TCI state/SRI of a specific BWP of the NCR-MT that is (e.g., explicitly) configured by the network through side control information via RRC/MAC CE/DCI. For example, the specific BWP (e.g., BWP ID) may be included in the MAC CE (e.g., MAC CE described later) that carries an NCR backhaul link beam indication.

In Option 2-2, NCR 300 (NCR-MT and/or NCR-Fwd) may receive information (e.g., BWP ID) related to a specific BWP of the NCR-MT from base station 100 through RRC/MAC CE/DCI, and select, determine, or configure the specific BWP corresponding to the indicated TCI state/SRI based on the information.

### [Option 3]

In a case where the NCR-MT is configured to have a plurality of serving cells and the NCR-Fwd is configured to have a plurality of carriers/cells (a plurality of carriers/cells are configured), the TCI states/SRIs of different serving cells of the NCR-MT may be indicated for different carriers/cells of the NCR-Fwd.

### Option 3-1

For each carrier/cell of the NCR-Fwd backhaul link, the indicated TCI state/SRI of the NCR-MT C-link may be, for example, the TCI state/SRI of a specific serving cell of the NCR-MT that is selected, determined, or configured based on specific conditions/rules as follows:
In a case where the band of the carrier/cell of the NCR-Fwd backhaul link is the same as the band of the carrier/serving cell of the NCR-MT, the specific serving cell is the serving cell.
In a case where the bandwidth of the carrier/cell of the NCR-Fwd backhaul link is the same as the bandwidth of the carrier/serving cell of the NCR-MT, the specific serving cell is the serving cell.
In a case where the center frequency of the carrier/cell of the NCR-Fwd backhaul link is the same as the center frequency of the carrier/serving cell of the NCR-MT, the specific serving cell is the serving cell.
In a case where the bandwidth of the carrier/cell of the NCR-Fwd backhaul link is within the bandwidth of the carrier/serving cell of the NCR-MT, the specific serving cell is the serving cell.
In a case where the bandwidth of the carrier/serving cell of the NCR-MT is within the bandwidth of the carrier/cell of the NCR-Fwd backhaul link, the specific serving cell is the serving cell.
In a case where the bandwidth of the carrier/cell of the NCR-Fwd backhaul link overlaps with the bandwidth of the carrier/serving cell of the NCR-MT, the specific serving cell is the serving cell.
In a case where the carrier/cell of the NCR-Fwd backhaul link is configured to have the same cell index as the carrier/serving cell of the NCR-MT (the same cell index as the carrier/serving cell of the NCR-MT is configured), the specific serving cell is the serving cell.
In a case where a plurality of serving cells of the NCR-MT satisfies the above-described condition, one serving cell of the NCR-MT is selected, determined, or configured according to a further rule. For example, in a case where the PCell of the NCR-MT satisfies the condition, the PCell of the NCR-MT is selected, determined, or configured, the serving cell of the NCR-MT having the highest/lowest cell index is selected, determined, or configured, or the like.

In Option 3-1, NCR 300 (NCR-MT and/or NCR-Fwd) may select, determine, or configure a specific BWP corresponding to the indicated TCI state/SRI for each carrier/cell of the NCR-Fwd backhaul link based on the specific condition/rule as described above.

### Option 3-2

For each carrier/cell of the NCR-Fwd backhaul link, the indicated TCI state/SRI of the NCR-MT C-link may be, for example, the TCI state/SRI of a specific serving cell of the NCR-MT that is (e.g., explicitly) configured by the network through side control information via RRC/MAC CE/DCI. For example, the specific serving cell (e.g., serving cell ID) may be included in the MAC CE/DCI that carries an NCR backhaul link beam indication.

In Option 3-2, NCR 300 (NCR-MT and/or NCR-Fwd) may receive information (e.g., serving cell ID) related to a specific serving cell of the NCR-MT from base station 100 for each carrier/cell of the NCR-Fwd backhaul link through RRC/MAC CE/DCI, and select, determine, or configure the specific serving cell corresponding to the indicated TCI state/SRI based on the information.

### [Option 4]

In a case where the NCR-MT is configured to have a plurality of DL BWPs/UL BWPs in a serving cell and the NCR-Fwd is configured to have a plurality of carriers/cells, the TCI states/SRIs of different BWPs of the NCR-MT may be indicated for different carriers/cells of the NCR-Fwd.

### Option 4-1

For each carrier/cell of the NCR-Fwd backhaul link, the indicated TCI state/SRI of the NCR-MT C-link may be, for example, the TCI state/SRI of a specific BWP of the NCR-MT that is selected, determined, or configured based on specific conditions/rules as follows:
The specific BWP is an active DL/UL BWP of the NCR-MT.
The specific BWP is a DL/UL BWP of the NCR-MT having the highest/lowest BWP index.

In Option 4-1, NCR 300 (NCR-MT and/or NCR-Fwd) may select, determine, or configure a specific BWP corresponding to the indicated TCI state/SRI for each carrier/cell of the NCR-Fwd backhaul link based on the specific condition/rule as described above.

### Option 4-2

For each carrier/cell of the NCR-Fwd backhaul link, the indicated TCI state/SRI of the NCR-MT C-link may be, for example, the TCI state/SRI of a specific BWP of the NCR-MT that is (e.g., explicitly) configured by the network through side control information via RRC/MAC CE/DCI. For example, the specific BWP (e.g., BWP ID) may be included in the MAC CE/DCI that carries an NCR backhaul link beam indication.

In Option 4-2, NCR 300 (NCR-MT and/or NCR-Fwd) may receive information (e.g., BWP ID) related to a specific BWP of the NCR-MT from base station 100 for each carrier/cell of the NCR-Fwd backhaul link through RRC/MAC CE/DCI, and select, determine, or configure the specific BWP corresponding to the indicated TCI state/SRI based on the information.

According to Proposal 2, it becomes clear to which serving cell/BWP of the C-link the indicated TCI state/SRI of the C-link of the NCR-MT corresponds, and even when the NCR-MT (C-link) operates on a plurality of carriers/serving cells/BWPs, the signal can be appropriately relayed.

### Proposal 3

In relation to the problem 2, a configuration example of the MAC CE in a case where the Rel-15 beam indication framework is used by the NCR-MT will be described.

### [Option 1]

One MAC CE may include either an NCR backhaul DL beam indication or an NCR backhaul UL beam indication.

### Option 1-1

Different MAC CEs (having different logical channel IDs (LCIDs)) may be used for the NCR backhaul DL beam indication and the NCR backhaul UL beam indication, respectively.

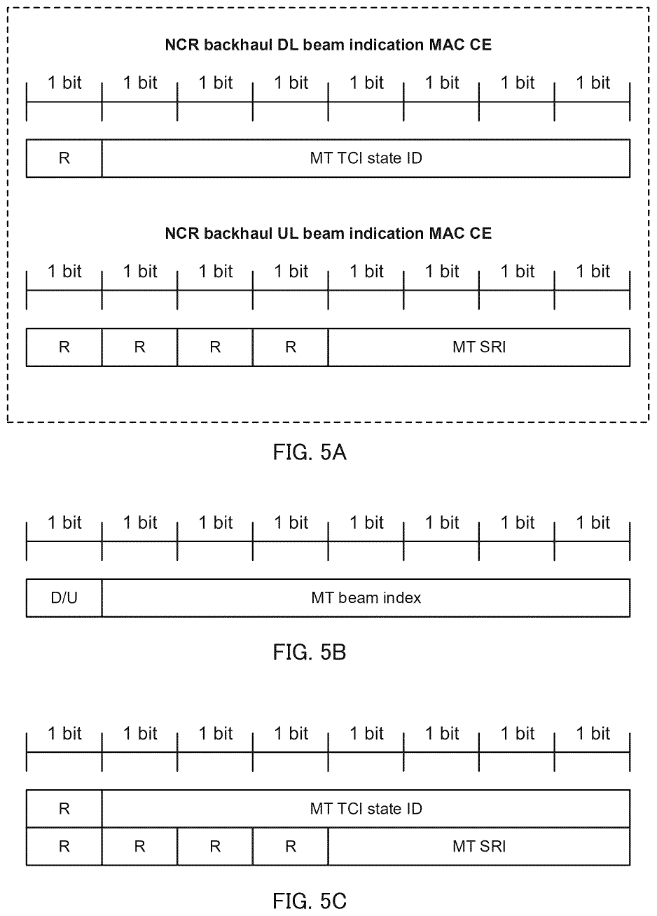

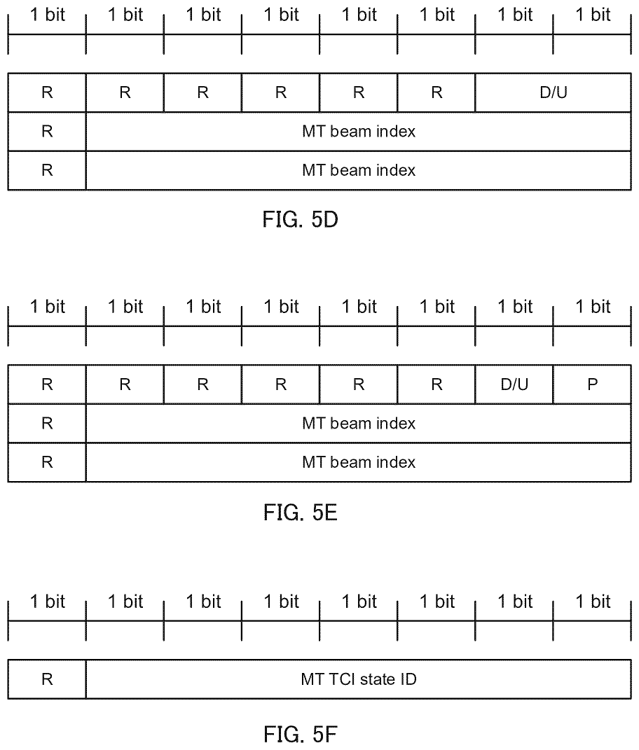

For example, as illustrated on the upper side of FIG. 5A, the MAC CE for the NCR backhaul DL beam indication may have a configuration in which the most significant bit is a reserved bit (denoted by “R,” and the same applies to other drawings) and an “MT TCI state ID” field is provided in lower 7 bits. Information indicated in this field may be an MT TCI state (ID). Arrangements of bits illustrated in FIG. 5A and various other drawings are not limited to the illustrated examples.

In addition, for example, as illustrated on the lower side of FIG. 5A, the MAC CE for the NCR backhaul UL beam indication may have a configuration in which upper 4 bits are reserved bits and an “MT SRI” field is provided in lower 4 bits. Information indicated in this field may be an MT SRI.

In Option 1-1, NCR 300 (NCR-MT and/or NCR-Fwd) may identify the LCID to determine whether the MAC CE indicates a DL beam or a UL beam.

### Option 1-2

The same MAC CE may be used for the NCR backhaul DL beam indication and the NCR backhaul UL beam indication, and a certain field in the same MAC CE may indicate whether the same MAC CE indicates a DL beam or a UL beam.

For example, as illustrated in FIG. 5B, the same MAC CE may have a configuration in which the most significant bit is a “D/U” field for indicating either DL beam or a UL beam, and an “MT beam index” field is provided in lower 7 bits. In a case where the “D/U” field indicates “1” (indicating a DL beam), the information indicated in the “MT beam index” field may be an MT TCI state (ID) (including all X bits (in this example, X=7)). On the other hand, in a case where the “D/U” field indicates “0” (indicating a UL beam), the information indicated in the “MT beam index” field may be an MT SRI (included in lower Y bits (in this example, Y=4) of this field). The values “0” and “1” that may be taken by the “D/U” field may have opposite meanings. That is, “1” may indicate a UL beam and “0” may indicate a DL beam.

In Option 1-2, NCR 300 (NCR-MT and/or NCR-Fwd) may determine whether a MAC CE indicates a DL beam or a UL beam, based on a value of a certain field (e.g., “D/U” field) in the MAC CE.

### [Option 2]

One MAC CE may always include both an NCR backhaul DL beam indication and an NCR backhaul UL beam indication.

For example, as illustrated in FIG. 5C, one MAC CE may have a configuration in which the configuration of the MAC CE for the NCR backhaul DL beam indication and the configuration of the MAC CE for the NCR backhaul UL beam indication illustrated in FIG. 5A are combined.

### [Option 3]

One MAC CE may include both an NCR backhaul DL beam indication and an NCR backhaul UL beam indication, may include only the NCR backhaul DL beam indication, or may include only the NCR backhaul UL beam indication.

In this case, a certain field in the MAC CE may indicate whether the MAC CE includes both the NCR backhaul DL beam indication and the NCR backhaul UL beam indication, includes only the NCR backhaul DL beam indication, or includes only the NCR backhaul UL beam indication.

For example, as illustrated in FIG. 5D, the MAC CE may have a configuration in which the MAC CE includes, in one octet, a two-bit “D/U” field for indicating whether this MAC CE includes both the NCR backhaul DL beam indication and the NCR backhaul UL beam indication, includes only the NCR backhaul DL beam indication, or includes only the NCR backhaul UL beam indication, and includes an “MT beam index” field in lower 7 bits in each of two octets. In a case where the “D/U” field indicates “00” (indicating only a DL beam), one “MT beam index” field is indicated between the two “MT beam index” fields, and the information indicated in this field may be an MT TCI state (ID) (including all X bits (in this example, X=7)). In a case where the “D/U” field indicates “01” (indicating only a UL beam), one “MT beam index” field is indicated between the two “MT beam index” fields, and the information indicated in this field may be an MT SRI (included in lower Y bits (in this example, Y=4) of this field). Alternatively, in a case where the “D/U” field indicates “10” (indicating both the DL beam and the UL beam), two “MT beam index” fields are indicated, the information indicated in one field may be an MT TCI state (ID) (including all X bits (in this example, X =7)), and the information indicated in the other field may be an MT SRI (included in lower Y bits (in this example, Y=4) of this field). The value “11” is for reservation. The values “00,” “01,” “10,” and “11” that may be taken by the “D/U” field may have meanings replaced with one another. For example, “00” may indicate only the UL beam, “01” may indicate both the DL beam and the UL beam, “11” may indicate only the DL beam, and so forth.

In Option 3, NCR 300 (NCR-MT and/or NCR-Fwd) may determine whether the MAC CE indicates both the DL beam and the UL beam, indicates only the DL beam, or indicates only the UL beam, based on a value of a certain field (e.g., “D/U” field) in the MAC CE.

In addition, as a variation of Option 3, one field in one MAC CE may indicate whether the MAC CE includes both the NCR backhaul DL beam indication and the NCR backhaul UL beam indication, or includes one of the NCR backhaul DL beam indication and the NCR backhaul UL beam indication. Then, in a case where this field indicates that the MAC CE includes one of the NCR backhaul DL beam indication and the NCR backhaul UL beam indication, another field in the MAC CE may indicate whether the MAC CE includes the NCR backhaul DL beam indication or the NCR backhaul UL beam indication.

For example, as illustrated in FIG. 5E, the MAC CE may have a configuration in which the MAC CE includes: in one octet, a one-bit “P” field for indicating whether this MAC CE includes both the NCR backhaul DL beam indication and the NCR backhaul UL beam indication, or includes one of the NCR backhaul DL beam indication and the NCR backhaul UL beam indication; and a “D/U” field for indicating whether the MAC CE includes the NCR backhaul DL beam indication or the NCR backhaul UL beam indication, and includes two “MT beam index” fields described with reference to FIG. 5D. In a case where the “P” field indicates “1” (this MAC CE includes both the NCR backhaul DL beam indication and the NCR backhaul UL beam indication), the same description as in a case where the “D/U” field indicates “10” (indicating both the DL beam and the UL beam) described with reference to FIG. 5D may be applied. In a case where the “P” field indicates “0” (this MAC CE includes one of the NCR backhaul DL beam indication and the NCR backhaul UL beam indication) and the “D/U” field indicates “0” (indicating the DL beam), the same description as in a case where the “D/U” field indicates “00” (indicating only the DL beam) described with reference to FIG. 5D may be applied. On the other hand, in a case where the “P” field indicates “0” and the “D/U” field indicates “1” (indicating the UL beam), the same description as in a case where the “D/U” field indicates “01” (indicating only the UL beam) described with reference to FIG. 5D may be applied. The values “0” and “1” that may be taken by the “P” field may have opposite meanings, and the values “0” and “1” that may be taken by the “D/U” field may have opposite meanings. In other words, regarding the “P” field, “1” may indicate that the MAC CE includes one of the NCR backhaul DL beam indication and the NCR backhaul UL beam indication, and “0” may indicate that the MAC CE includes both the NCR backhaul DL beam indication and the NCR backhaul UL beam indication. Furthermore, regarding the “D/U” field, “0” may indicate the UL beam and “1” may indicate the DL beam.

In the variation of Option 3, NCR 300 (NCR-MT and/or NCR-Fwd) may determine whether the MAC CE indicates both the DL beam and the UL beam or indicates one of the DL beam and the UL beam, based on a value of a certain field (e.g., “P” field) in the MAC CE. In the case whether one of the DL beam or the UL beam is indicated, NCR 300 may determine whether the MAC CE indicates the DL beam or the UL beam, based on a value of another field (e.g., “D/U” field) in the MAC CE.

### [Option 4]

One MAC CE may include one beam index (e.g., TCI state ID) that is applied to both the NCR backhaul DL and the NCR backhaul UL to be indicated.

Option 4 may be applicable in a case where DL and UL have beam correspondence.

For example, as illustrated in FIG. 5F, the MAC CE may have a configuration in which an “MT TCI state ID” field is provided in lower 7 bits. The indicated MT TCI state may be applied to both the NCR backhaul DL and the NCR backhaul UL.

Note that, in the above-described configuration examples of the MAC CE illustrated in FIGS. 5A to 5F, an NCR MT serving cell ID/NCR MT BWP ID/NCR MT DL BWP ID/NCR MT UL BWP ID may be included in accordance with Proposal 2.

In Proposal 3, NCR 300 operates as follows, for example. NCR 300 (e.g., NCR-MT) receives a list of beams that can be used by NCR 300 in the backhaul link (list of C-link beams) from base station 100 via the C-link by RRC signaling. NCR 300 (e.g., NCR-MT) receives, via the C-link, the above-described MAC CE including a beam indication related to a beam to be used by NCR 300 in the backhaul link. NCR 300 (e.g., NCR-Fwd) determines, based on the beam indication, the beam to be used by NCR 300 in the backhaul link from the configured list of beams that can be used by NCR 300, by performing the determination described above, for example.

According to Proposal 3, the configuration of a MAC CE including a backhaul link beam indication is clarified in a case where the Rel-15 beam indication framework is used for the NCR-MT, and a signal can be appropriately relayed.

### Proposal 4

In relation to the problem 2, a configuration example of a MAC CE in a case where the Rel-17 beam indication framework (unified TCI framework) is used by NCR-MT will be described.

### <<Case 1>>

In a case where joint DL/UL TCI (common or same TCI in DL and UL) is configured to the NCR-MT, one TCI state may be indicated and applied to both the NCR backhaul DL and the NCR backhaul UL. Here, the joint DL/UL TCI means that a common or same TCI may be indicated and applied to an NCR-MT DL channel/reference signal (RS) and an NCR-MT UL channel/RS. One MAC CE may include one “TCI state ID” field, for example.

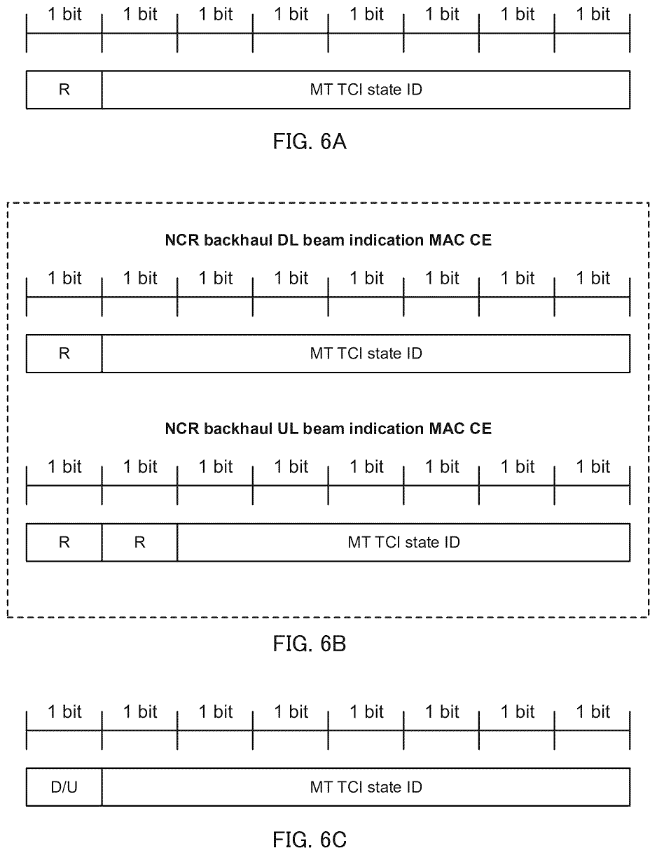

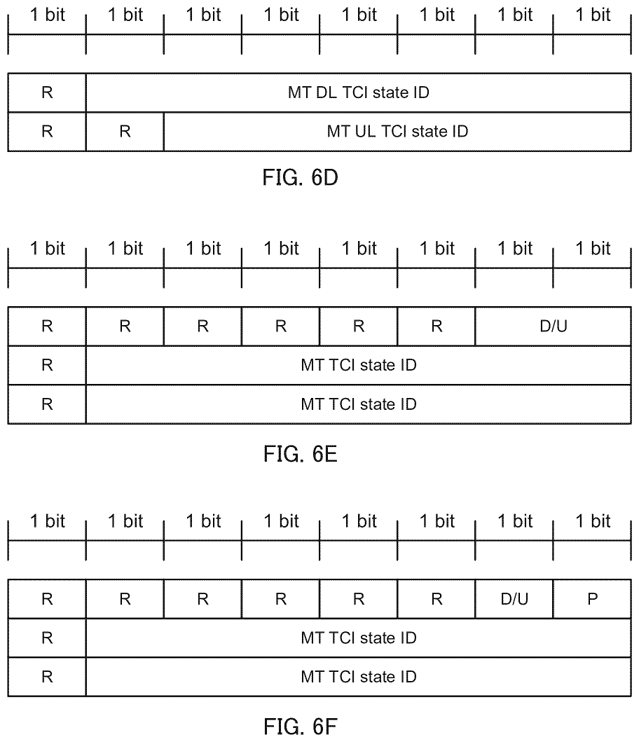

For example, as illustrated in FIG. 6A, the MAC CE may have a configuration in which an “MT TCI state ID” field is provided in lower 7 bits. The “MT TCI state ID” field may indicate a joint DL/UL TCI state (ID) of the NCR-MT.

### <<Case 2>>

In a case where separate DL/UL TCI (separate TCI in DL and UL) is configured to the NCR-MT, the respective separate TCI states may be indicated for the NCR backhaul DL and the NCR backhaul UL. Here, the separate DL/UL TCI means that separate TCIs may be indicated and applied to the NCR-MT DL channel/RS and the NCR-MT UL channel/RS, respectively. Note that Options 1 to 3 described below are similar to Options 1 to 3 in Proposal 2, respectively.

### [Option 1]

One MAC CE may include either an NCR backhaul DL beam indication or an NCR backhaul UL beam indication.

### Option 1-1

Different MAC CEs (having different LCIDs) may be used for the NCR backhaul DL beam indication and the NCR backhaul UL beam indication, respectively.

For example, as illustrated on the upper side of FIG. 6B, the MAC CE for the NCR backhaul DL beam indication may have a configuration in which the most significant bit is a reserved bit and an “MT TCI state ID” field is provided in lower 7 bits. The “MT TCI state ID” field may indicate a DL TCI state (ID) of the NCR-MT.

In addition, for example, as illustrated on the lower side of FIG. 6B, the MAC CE for the NCR backhaul UL beam indication may have a configuration in which upper 2 bits are reserved bits and an “MT TCI state ID” field is provided in lower 6 bits. The “MT TCI state ID” field may indicate a UL TCI state (ID) of the NCR-MT.

In Option 1-1, NCR 300 (NCR-MT and/or NCR-Fwd) may identify the LCID to determine whether the MAC CE indicates a DL beam or a UL beam.

### Option 1-2

The same MAC CE may be used for the NCR backhaul DL beam indication and the NCR backhaul UL beam indication, and a certain field in the same MAC CE may indicate whether the same MAC CE indicates a DL beam or a UL beam.

For example, as illustrated in FIG. 6C, the same MAC CE may have a configuration in which the most significant bit is a “D/U” field for indicating either a DL beam or a UL beam, and an “MT TCI state ID” field is provided in lower 7 bits. Here, in a case where the “D/U” field indicates “1” (indicating a DL beam), the information indicated in the “MT TCI state ID” field may be an MT DL TCI state (ID) (including all X bits (in this example, X=7)). On the other hand, in a case where the “D/U” field indicates “0” (indicating a UL beam), the information indicated in the “MT TCI state ID” field may be an MT UL TCI state (ID) (included in lower Y bits (in this example, Y=6) of this field, and the most significant bit of this field is regarded as reserved). The values “0” and “1” that may be taken by the “D/U” field may have opposite meanings. That is, “1” may indicate the UL beam and “0” may indicate the DL beam.

In Option 1-2, NCR 300 (NCR-MT and/or NCR-Fwd) may determine whether the MAC CE indicates a DL beam or a UL beam, based on a value of a certain field (e.g., “D/U” field) in the MAC CE.

### [Option 2]

One MAC CE may always include both the NCR backhaul DL beam indication and the NCR backhaul UL beam indication.

For example, as illustrated in FIG. 6D, one MAC CE may have a configuration in which the configuration of the MAC CE for the NCR backhaul DL beam indication and the configuration of the MAC CE for the NCR backhaul UL beam indication illustrated in FIG. 6B are combined. The “MT DL TCI state ID” field may indicate a DL TCI state (ID) of the NCR-MT, and the “MT UL TCI state ID” field may indicate a UL TCI state (ID) of the NCR-MT.

### [Option 3]

One MAC CE may include both the NCR backhaul DL beam indication and the NCR backhaul UL beam indication, may include only the NCR backhaul DL beam indication, or may include only the NCR backhaul UL beam indication.

In this case, a certain field in the MAC CE may indicate whether the MAC CE includes both the NCR backhaul DL beam indication and the NCR backhaul UL beam indication, includes only the NCR backhaul DL beam indication, or includes only the NCR backhaul UL beam indication.

For example, as illustrated in FIG. 6E, the MAC CE may have a configuration in which this MAC CE includes, in one octet, a two-bit “D/U” field for indicating whether the MAC CE includes both the NCR backhaul DL beam indication and the NCR backhaul UL beam indication, includes only the NCR backhaul DL beam indication, or includes only the NCR backhaul UL beam indication, and includes an “MT TCI state ID” field in lower 7 bits in each of two octets. Here, in a case where the “D/U” field indicates “00” (indicating only a DL beam), one “MT TCI state ID” field is indicated between the two “MT TCI state ID” fields, and the information indicated in this field may be an MT DL TCI state (ID) (including all X bits (in this example, X=7)). In a case where the “D/U” field indicates “01” (indicating only a UL beam), one “MT TCI state ID” field is indicated between the two “MT TCI state ID” fields, and the information indicated in this field may be an MT UL TCI state (ID) (included in lower Y bits (in this example, Y=6) of this field, and the most significant bit of this field is regarded as reserved). Alternatively, in a case where the “D/U” field indicates “10” (indicating both the DL beam and the UL beam), two “MT TCI state ID” fields are indicated, the information indicated in one field may be an MT DL TCI state (ID) (including all X bits (in this example, X=7)), and the information indicated in the other field may be an MT UL TCI state (ID) (included in lower Y bits (in this example, Y=6) of this field, and the most significant bit of this field is regarded as reserved). The value “11” is for reservation. Note that the values “00,” “01,” “10,” and “11” that may be taken by the “D/U” field may have meanings replaced with one another other. For example, “00” may indicate only the UL beam, “01” may indicate both the DL beam and the UL beam, “11” may indicate only the DL beam, and the like.

In Option 3, NCR 300 (NCR-MT and/or NCR-Fwd) may determine whether the MAC CE indicates both the DL beam and the UL beam, indicates only the DL beam, or indicates only the UL beam, based on a value of a certain field (e.g., “D/U” field) in the MAC CE.

In addition, as a variation of Option 3, one field in one MAC CE may indicate whether the MAC CE includes both the NCR backhaul DL beam indication and the NCR backhaul UL beam indication, or includes one of the NCR backhaul DL beam indication and the NCR backhaul UL beam indication. Then, in a case where this field indicates that the MAC CE includes one of the NCR backhaul DL beam indication and the NCR backhaul UL beam indication, another field in the MAC CE may indicate whether the MAC CE includes the NCR backhaul DL beam indication or the NCR backhaul UL beam indication.

For example, as illustrated in FIG. 6E, the MAC CE may have a configuration in which this MAC CE includes: in one octet, a one-bit “P” field for indicating whether the MAC CE includes both the NCR backhaul DL beam indication and the NCR backhaul UL beam indication, or includes one of the NCR backhaul DL beam indication and the NCR backhaul UL beam indication; and a “D/U” field for indicating whether the MAC CE includes the NCR backhaul DL beam indication or the NCR backhaul UL beam indication, and includes the two “MT TCI state ID” fields described with reference to FIG. 6E. Here, in a case where the “P” field indicates “1” (indicating that this MAC CE includes both the NCR backhaul DL beam indication and the NCR backhaul UL beam indication), the same description as in a case where the “D/U” field indicates “10” (indicating both the DL beam and the UL beam) described with reference to FIG. 6E may be applied. In addition, in a case where the “P” field indicates “0” (indicating that this MAC CE includes one of the NCR backhaul DL beam indication and the NCR backhaul UL beam indication) and the “D/U” field indicates “0” (indicating the DL beam), the same description as in a case where the “D/U” field indicates “00” (indicating the DL beam) described with reference to FIG. 6E may be applied. On the other hand, in a case where the “P” field indicates “0” and the “D/U” field indicates “1” (indicating the UL beam), the same description as in a case where the “D/U” field indicates “01” (indicating the UL beam) described with reference to FIG. 6F may be applied. The values “0” and “1” that may be taken by the “P” field may have opposite meanings, and the values “0” and “1” that may be taken by the “D/U” field may have opposite meanings. That is, regarding the “P” field, “1” may indicate that the MAC CE includes one of the NCR backhaul DL beam indication and the NCR backhaul UL beam indication, and “0” may indicate that the MAC CE includes both the NCR backhaul DL beam indication and the NCR backhaul UL beam indication. Furthermore, regarding the “D/U” field, “0” may indicate the UL beam and “1” may indicate the DL beam.

In the variation of Option 3, NCR 300 (NCR-MT and/or NCR-Fwd) may determine whether the MAC CE indicates both the DL beam and the UL beam or indicates one of the DL beam and the UL beam, based on a value of a certain field (e.g., “P” field) in the MAC CE. In the case where one of the DL beam and the UL beam is indicated, NCR 300 may determine whether the MAC CE indicates the DL beam or the UL beam, based on a value of another field (e.g., “D/U” field) in the MAC CE.

As a variation of Case 2, in a case where the joint DL/UL TCI is configured to the NCR-MT, the respective separate TCI states may be indicated for the NCR backhaul DL and the NCR backhaul UL. In the present variation, Options 1 to 3 of Case 2 described above may be applied.

Note that, in the above-described configuration examples of the MAC CE illustrated in FIGS. 6A to 6F, an NCR MT serving cell ID/NCR MT BWP ID/NCR MT DL BWP ID/NCR MT UL BWP ID may be included in accordance with Proposal 2.

In Proposal 4, NCR 300 operates as follows, for example. NCR 300 (e.g., NCR-MT) receives a list of beams that can be used by NCR 300 in the backhaul link (list of C-link beams) from base station 100 via the C-link by RRC signaling. NCR 300 (e.g., NCR-MT) receives, via the C-link, the above-described MAC CE including the beam indication related to a beam to be used by NCR 300 in the backhaul link. NCR 300 (e.g., NCR-Fwd) determines the beam to be used by NCR 300 in the backhaul link from the configured list of beams that can be used by NCR 300 by performing, for example, the determination described above, based on the beam indication.

According to Proposal 4, the configuration of a MAC CE including a backhaul link beam indication is clarified in a case where the Rel-17 beam indication framework is used for the NCR-MT, and a signal can be appropriately relayed.

### Proposal 5

In relation to the problem 2, in a case where the Rel-17 beam indication framework (unified TCI framework) is used by NCR-MT, a relationship between a case of joint DL/UL TCI (Case 1 described above) and a case of separate DL/UL TCI (Case 2 described above) may be a relationship described in the following Option 1 or 2.

### [Option 1]

Different MAC CEs (having different LCIDs) may be used between the case of the joint DL/UL TCI and the case of the separate DL/UL TCI.

In Option 1, NCR 300 (NCR-MT and/or NCR-Fwd) may identify the LCID to determine whether the MAC CE is for the case of the joint DL/UL TCI or the case of the separate DL/UL TCI.

### [Option 2]

The same MAC CE may be used between the case of the joint DL/UL TCI and the case of the separate DL/UL TCI.

### Option 2-1

A certain field in the same MAC CE may indicate either the case of the joint DL/UL TCI or the case of the separate DL/UL TCI (whether the same MAC CE is for the case of the joint DL/UL TCI or the case of the separate DL/UL TCI).

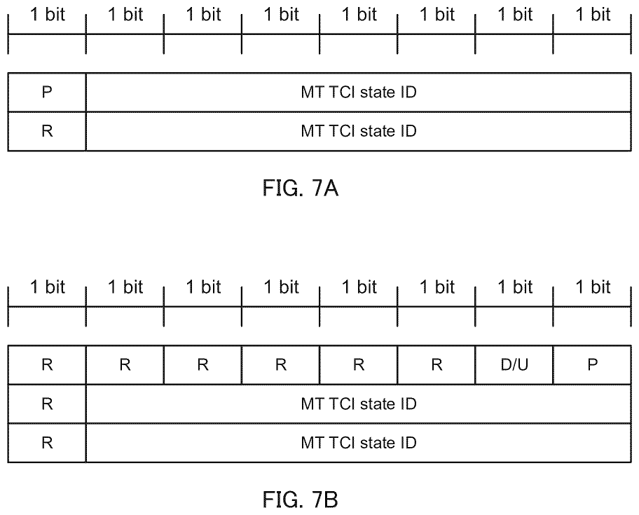

For example, as illustrated in FIG. 7A, the same MAC CE may have a configuration in which the same MAC CE includes a one-bit “P” field indicating whether the same MAC CE is for the case of the joint DL/UL TCI or the case of the separate DL/UL TCI, and indicating whether one of two “MT TCI state ID” fields described below is indicated or both of the two “MT TCI state ID” fields are indicated, and includes the two “MT TCI state ID” fields. In a case where the “P” field indicates “0” (indicating the case of the joint DL/UL TCI), one “MT TCI state ID” field is indicated between the two “MT TCI state ID” fields, and the information indicated in this field may be a joint DL/UL TCI state (ID). On the other hand, in a case where the “P” field indicates “1” (indicating the case of the separate DL/UL TCI), two “MT TCI state ID” fields are indicated, the information indicated in one field may be an MT DL TCI state (ID) (including all X bits (in this example, X=7)), and the information indicated in the other field may be an MT UL TCI state (ID) (included in lower Y bits (in this example, Y=6) of this field, and the most significant bit of this field is regarded as reserved). The values “0” and “1” that may be taken by the “P” field may have opposite meanings. That is, “0” may indicate the case of the separate DL/UL TCI, and “1” may indicate the case of the joint DL/UL TCI.

In Option 2-1, NCR 300 (NCR-MT and/or NCR-Fwd) may determine whether the MAC CE is for the case of the joint DL/UL TCI or the case of the separate DL/UL TCI, based on a value of a certain field (e.g., “P” field) in the MAC CE.

### Option 2-2

Which of the case of the joint DL/UL TCI or the case of the separate DL/UL TCI is adopted (whether the same MAC CE is for the case of the joint DL/UL TCI or the case of the separate DL/UL TCI) may be based on an higher layer configuration (e.g., RRC configuration).

For example, as illustrated in FIG. 7B, the MAC CE may have a configuration in which the MAC CE includes: in one octet, a one-bit “P” field for indicating whether one of two “MT TCI state ID” fields described below is indicated or both of the two “MT TCI state ID” fields are indicated; and a “D/U” field for indicating whether the MAC CE includes the NCR backhaul DL beam indication or the NCR backhaul UL beam indication, and includes an “MT TCI state ID” field in lower 7 bits in each of two octets.

In a case where the “P” field indicates “0,” one “MT TCI state ID” field may be indicated between the two “MT TCI state ID” fields, as described above. Then, in a case where the higher layer configures the case of the joint DL/UL TCI, the information indicated in this field may be a joint DL/UL TCI state (ID). In this case, the “D/U” field need not be present. On the other hand, in a case where the higher layer configures the case of the separate DL/UL TCI, the information indicated in the one “MT TCI state ID” field between the two “MT TCI state ID” fields may vary depending on the value of the “D/U” field. Specifically, in a case where the “D/U” field indicates “0” (indicating a DL beam), the information indicated in this field may be an MT DL TCI state (ID) (including all X bits (in this example, X=7)). On the other hand, in a case where the “D/U” field indicates “1” (indicating the UL beam), the information indicated in this field may be an MT UL TCI state (ID) (included in lower Y bits (in this example, Y=6) of this field, and the most significant bit of this field is regarded as reserved).

In a case where the “P” field indicates “1,” as described above, two “MT TCI state ID” fields may be indicated, the information indicated in one field may be an MT DL TCI state (ID) (including all X bits (in this example, X=7)), and the information indicated in the other field may be an MT UL TCI state (ID) (included in lower Y bits (in this example, Y=6) of this field, and the most significant bit of this field is regarded as reserved).

The values “0” and “1” that may be taken by the “P” field may have opposite meanings, and the values “0” and “1” that may be taken by the “D/U” field may have opposite meanings. That is, regarding the “P” field, “1” may indicate that one “MT TCI state ID” field is indicated, and “0” may indicate that two “MT TCI state ID” fields are indicated. Furthermore, regarding the “D/U” field, “0” may indicate the UL beam and “1” may indicate the DL beam.

In addition, in a case where the configuration of the MAC CE in Option 2 or 3 described in Proposal 4 is used, and the higher layer configures the case of the joint DL/UL TCI, one “MT TCI state ID” field may be indicated, and the information indicated in this field may be a joint DL/UL TCI state (ID). In this case, another field need not be present. On the other hand, in a case where the configuration of the MAC CE in Option 2 or 3 described in Proposal 4 is used, and the higher layer configures the case of the separate DL/UL TCI, the description in Option 2 or 3 described in Proposal 4 may be applied.

In Option 2-2, NCR 300 (NCR-MT and/or NCR-Fwd) may determine whether the MAC CE is for the case of the joint DL/UL TCI or the case of the separate DL/UL TCI, based on a higher layer configuration (e.g., RRC configuration).

Note that the configuration (content) of the MAC CE in the case of the joint DL/UL TCI and the configuration (content) of the MAC CE in the case of the separate DL/UL TCI in Proposal 5 may be the same as or similar to the configurations (contents) described above in Proposal 4 (e.g., see FIGS. 6A to 6F).

In Proposal 5, NCR 300 operates as follows, for example. NCR 300 (e.g., NCR-MT) receives a list of beams that can be used by NCR 300 in the backhaul link (list of C-link beams) from base station 100 via the C-link by RRC signaling. NCR 300 may receive configuration information related to which of the case of the joint DL/UL TCI or the case of the separate DL/UL TCI is used, from base station 100 via the C-link by RRC signaling. NCR 300 (e.g., NCR-MT) receives, via the C-link, the MAC CE including the beam indication related to a beam to be used by NCR 300 in the backhaul link. NCR 300 (e.g., NCR-Fwd) determines whether to use the case of the joint DL/UL TCI or the case of the separate DL/UL TCI, based on the beam indication or the configuration information, and determines the beam to be used by NCR 300 in the backhaul link from the configured list of beams that can be used by NCR 300.

According to Proposal 5, the configuration of the MAC CE is clarified in a case where the Rel-17 beam indication framework is used for the NCR-MT, and a signal can be appropriately relayed.

### Proposal 6

In relation to the problem 2, a relationship between the MAC CE for the case of the Rel-15 beam indication framework and the MAC CE for the case of the Rel-17 beam indication framework may be a relationship described in the following Option 1 or 2. Note that the case of the Rel-15 beam indication framework refers to a case where the Rel-15 beam indication framework is used for the NCR-MT, and the case of the Rel-17 beam indication framework refers to a case where the Rel-17 beam indication framework is used for the NCR-MT.

### [Option 1]

Different MAC CEs (having different LCIDs) may be used between the case of the Rel-15 beam indication framework and the case of the Rel-17 beam indication framework.

In Option 1, NCR 300 (NCR-MT and/or NCR-Fwd) may identify the LCID to determine whether the MAC CE is for the case of the Rel-15 beam indication framework or the case of the Rel-17 beam indication framework.

### [Option 2]

The same MAC CE may be used between the case of the Rel-15 beam indication framework and the case of the Rel-17 beam indication framework.

### Option 2-1

A certain field in the same MAC CE may indicate either the case of the Rel-15 beam indication framework or the case of the Rel-17 beam indication framework (whether the same MAC CE is for the case of the Rel-15 beam indication framework or the case of the Rel-17 beam indication framework).

In Option 2-1, NCR 300 (NCR-MT and/or NCR-Fwd) may determine whether the MAC CE is for the case of the Rel-15 beam indication framework or the case of the Rel-17 beam indication framework, based on a value of a certain field in the MAC CE.

### Option 2-2

Which of the case of the Rel-15 beam indication framework or the case of the Rel-17 beam indication framework is adopted (whether the same MAC CE is for the case of the Rel-15 beam indication framework or the case of the Rel-17 beam indication framework) may be based on an higher layer configuration (e.g., RRC configuration).

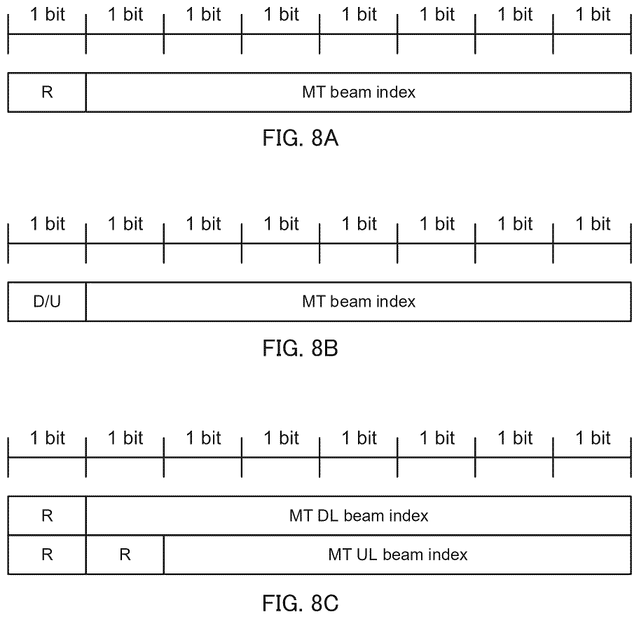

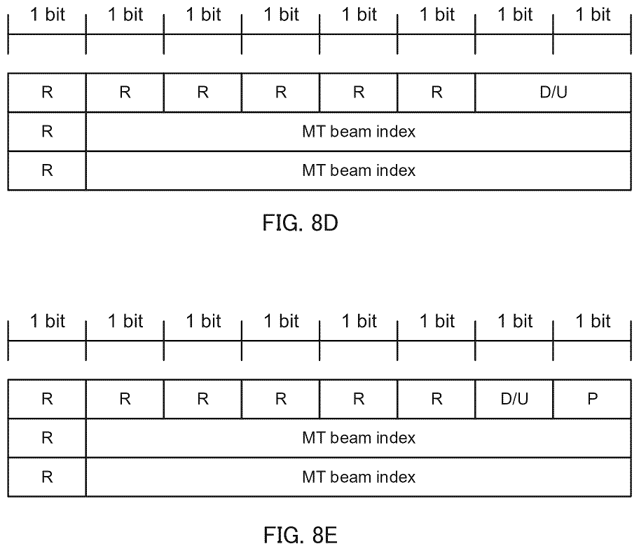

For example, the information indicated in the “MT beam index” field in lower 7 bits illustrated in FIG. 8A may vary depending on the higher layer configuration. Specifically, in a case where the higher layer configures the case of the Rel-15 beam indication framework, the “MT beam index” field may indicate an MT TCI state (ID). On the other hand, in a case where the higher layer configures the case of the Rel-17 beam indication framework, the “MT beam index” field may indicate an MT joint DL/UL TCI state (ID) and may be applied to both the NCR backhaul DL and the NCR backhaul UL.

In addition, for example, the information indicated in the “MT beam index” field in lower 7 bits illustrated in FIG. 8B may vary depending on the higher layer configuration. Specifically, in a case where the higher layer configures the case of the Rel-15 beam indication framework, the “MT beam index” field may indicate an MT TCI state (ID) or SRI in accordance with the description in Options 1 and 2 of Proposal 3. On the other hand, in a case where the higher layer configures the case of the Rel-17 beam indication framework, the “MT beam index” field may indicate an MT DL TCI state (ID) or an MT UL TCI state (ID) in accordance with the description in Options 1 and 2 of Proposal 4.

In addition, for example, the information indicated in the “MT UL beam index” field in lower 6 bits illustrated in FIG. 8C may vary depending on the higher layer configuration. Specifically, in a case where the higher layer configures the case of the Rel-15 beam indication framework, the “MT UL beam index” field may indicate an MT SRI in accordance with the description in Option 2 of Proposal 3. On the other hand, in a case where the higher layer configures the case of the Rel-17 beam indication framework, the “MT UL beam index” field may indicate an MT UL TCI state (ID) in accordance with the description in Option 2 of Proposal 4.

In addition, for example, the information indicated in the “MT beam index” field in lower 7 bits illustrated in FIG. 8D may vary depending on the higher layer configuration. Specifically, in a case where the higher layer configures the case of the Rel-15 beam indication framework, the “MT beam index” field may indicate an MT TCI state (ID) or SRI in accordance with the description in Option 3 of Proposal 3. On the other hand, in a case where the higher layer configures the case of the Rel-17 beam indication framework, the “MT beam index” field may indicate an MT DL TCI state (ID) or an MT UL TCI state (ID) in accordance with the description in Option 3 of Proposal 4.

In addition, for example, the information indicated in the “MT beam index” field in lower 7 bits illustrated in FIG. 8E may vary depending on the higher layer configuration. Specifically, in a case where the higher layer configures the case of the Rel-15 beam indication framework, the “MT beam index” field may indicate an MT TCI state (ID) or SRI in accordance with the description in the variation of Option 3 of Proposal 3. On the other hand, in a case where the higher layer configures the case of the Rel-17 beam indication framework, the “MT beam index” field may indicate an MT DL TCI state (ID) or an MT UL TCI state (ID) in accordance with the description in the variation of Option 3 of Proposal 4.

In Option 2-2, NCR 300 (NCR-MT and/or NCR-Fwd) may determine whether the MAC CE is for the case of the Rel-15 beam indication framework or the case of the Rel-17 beam indication framework, based on the higher layer configuration (e.g., RRC configuration).

Note that, in Proposal 6, the configuration (content) of the MAC CE in the case of the Rel-15 beam indication framework and the configuration (content) of the MAC CE in the case of the Rel-17 beam indication framework may be the same as or similar to the configurations (contents) described above in Proposal 3 or 4 (e.g., see FIGS. 5A to 5F or FIGS. 6A to 6F).

In Proposal 6, NCR 300 operates as follows, for example. NCR 300 (e.g., NCR-MT) receives a list of beams that can be used by NCR 300 in the backhaul link (list of C-link beams) from base station 100 via the C-link by RRC signaling. NCR 300 may receive configuration information related to which of the case of the Rel-15 beam indication framework or the case of the Rel-17 beam indication framework is used, from base station 100 via the C-link by RRC signaling. NCR 300 (e.g., NCR-MT) receives, via the C-link, the MAC CE including the beam indication related to a beam to be used by NCR 300 in the backhaul link. NCR 300 (e.g., NCR-Fwd) determines whether to use the case of the Rel-15 beam indication framework or the case of the Rel-17 beam indication framework, based on the beam indication or the configuration information, and determines the beam to be used by NCR 300 in the backhaul link from the configured list of beams that can be used by NCR 300.

According to Proposal 6, the configuration of the MAC CE is clarified in a case where both the Rel-15 beam indication framework and the Rel-17 beam indication framework are used for the NCR-MT, and a signal can be appropriately relayed.

In the above-described proposals, base station 100 operates as follows, for example. Base station 100 transmits the list of the C-link beams to NCR 300 (e.g., NCR-MT) via the C-link by RRC signaling. Base station 100 may transmit, to NCR 300 (e.g., NCR-MT) via the C-link by RRC signaling, the configuration information related to which of the case of the joint DL/UL TCI or the case of the separate DL/UL TCI is used and/or the configuration information related to which of the case of the Rel-15 beam indication framework or the case of the Rel-17 beam indication framework is used. Base station 100 transmits the MAC CE including the backhaul link beam indication, which may be any of the MAC CEs described in the proposals, to NCR 300 (e.g., NCR-MT) via the C-link. Base station 100 communicates with terminal 200 via the backhaul link and the access link, relaying through NCR 300 (e.g., NCR-Fwd).

### Operation Example

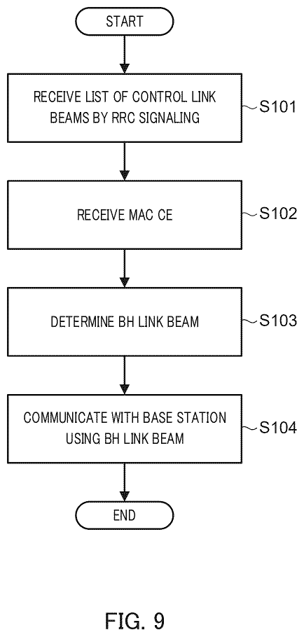

FIG. 9 is a flowchart illustrating an operation example of relay apparatus (NCR) 300 according to an embodiment of the present disclosure.

In step S101, NCR 300 receives a list of control link beams (C-link beams) from base station 100 via the control link (C-link) by RRC signaling.

In step S102, NCR 300 receives a MAC CE including a beam indication from base station 100 via the C-link. This MAC CE may be any of the MAC CEs described in the proposals.

In step S103, NCR 300 determines or configures a backhaul link beam based on the received list of the control link beams (C-link beams) and the MAC CE (beam indication), as described in the proposals. For example, NCR 300 determines a beam corresponding to the TCI state (ID) or the SRI in the MAC CE (beam indication) from the list of the control link beams (C-link beams) as the backhaul link beam. The backhaul link beam may be used when NCR 300 receives control information or data transmitted from base station 100 and addressed to terminal 200 or when NCR 300 transmits, to base station 100, control information or data that is transmitted from terminal 200, received by NCR 300, and addressed to base station 100.

In step S104, NCR 300 communicates with base station 100 in the DL or UL via the backhaul link using the determined backhaul link beam.

### Variation

As a variation of the present proposals, the following can be considered.

[Variation 1]

In the above description, an example has been described in which the list of beams for the C-link is configured by RRC, and NCR 300 determines the beam for the backhaul link from this list based on the MAC CE, but an independent list of beams for the backhaul link may be configured by RRC, separately from the list of beams for the C-link. Then, NCR 300 may determine the beam for the backhaul link from the list of beams for the backhaul link based on the MAC CE including the backhaul link beam indication as described above.

### Capability of NCR

The NCR may report the following capabilities to the base station as capabilities related to beam indication:
Support (capability) of adaptive beam control for an NCR backhaul link
Support (capability) of an NCR backhaul link beam indicated by an MAC CE

The NCR may report the following capabilities as capabilities for a frequency band supported:
Capability for all bands (e.g., single capability) (e.g., capability as NCR)
Capability for each frequency band
Capability for each frequency range (e.g., capability in each of FR1, FR2, and the like)

Note that the single capability may correspond to one capability for all bands, instead of each capability for each frequency band.

The NCR may report the following capabilities as capabilities for duplex supported:
Capability for all duplexes (e.g., single capability) (e.g., capability as repeater)
Capability for each duplex (e.g., capability in each of TDD, FDD, and the like)

The single capability may correspond to one capability for all duplexes, instead of each capability for each duplex.

In addition, the NCR may report to the base station whether the NCR supports each of the Options and the like of the above-described Proposals as the capability of the NCR.

For example, the above-described Proposals may be applied in a case where a corresponding capability is supported by the NCR and/or in a case where the corresponding capability is activated by higher layer signaling.

### Apparatus Configuration

Next, an exemplary functional configuration of base station 100 and terminal 200 that execute the processing and operations described so far will be described. Base station 100 and terminal 200 may have functions for implementing the embodiment described above. Note that base station 100 and terminal 200 may each have only some of the functions described in the embodiment.

### Base Station

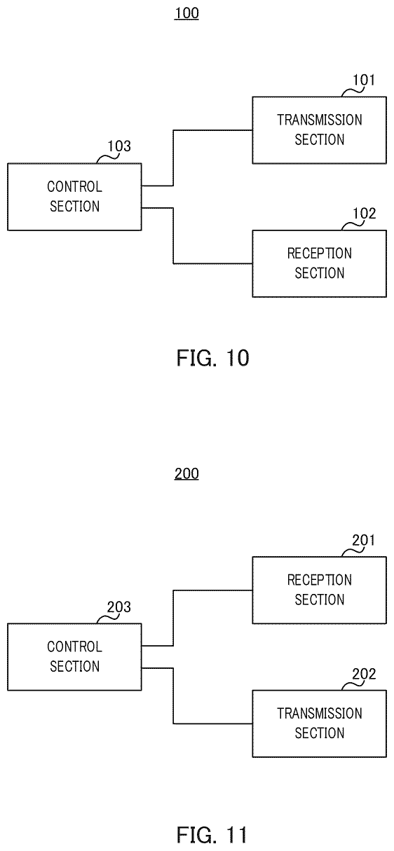

FIG. 10 is a block diagram illustrating an exemplary configuration of base station 100 according to an embodiment of the present disclosure. The base station includes, for example, transmission section 101, reception section 102, and control section 103. Base station 100 communicates with terminal 200 (see FIG. 11) by radio. Note that, transmission section 101 and reception section 102 may be collectively referred to as a communication section.

Transmission section 101 transmits a DL signal to terminal 200. For example, transmission section 101 transmits a DL signal under the control of control section 103. For example, the DL signal may include information indicating scheduling related to signal transmission of terminal 200 (e.g., UL grant), control information of a higher layer, and the like.

For example, transmission section 101 transmits various control signals (such as control signals in the RRC layer), reference signals, data signals, and the like as DL signals to terminal 200 and/or relay apparatus 300. Transmission section 101 transmits, for example, various signals, channels, configuration information, control information, and the like described in the above embodiment to terminal 200 as DL signals.

For example, transmission section 101 transmits information related to the control of terminal 200 and/or information related to the control of relay apparatus 300, which are generated by control section 103, to terminal 200. Further, transmission section 101 transmits the data signal generated by control section 103 to terminal 200.

Reception section 102 receives a UL signal transmitted from terminal 200. For example, reception section 102 receives a UL signal under the control of control section 103. Further, reception section 102 may receive a UL signal transmitted from relay apparatus 300.

For example, reception section 102 receives, as a UL signal, a signal including terminal capability information (e.g., UE capability) of terminal 200, various control signals, reference signals, data signals, and the like from terminal 200. Further, reception section 102 may receive a signal including capability information of relay apparatus 300 (e.g., NCR capability).

Control section 103 controls the overall (communication) operation of base station 100, including the transmission processing in transmission section 101 and the reception processing in reception section 102.

For example, control section 103 acquires information such as data and control information from a higher layer and outputs the information to transmission section 101. Further, control section 103 outputs the data and control information received from reception section 102 to a higher layer.

For example, control section 103 allocates resources for the transmission and reception of DL signals and/or resources for the transmission and reception of UL signals, based on signals (e.g., data, control information, and the like) received from terminal 200 and/or data and control information acquired from a higher layer. Information on the allocated resource may be included in control information to be transmitted to terminal 200.

Control section 103 executes operations other than the transmission and reception described in the above embodiment (the operations may be executed by transmission section 101 and/or reception section 102).

Furthermore, control section 103 may generate control information related to the forwarding operation of relay apparatus 300. Control section 103 may perform resource allocation of the resource to be allocated to relay apparatus 300. Control section 103 may perform an indication related to communication control of relay apparatus 300 via transmission section 101.

### Terminal

FIG. 11 is a block diagram illustrating an exemplary configuration of terminal 200 according to an embodiment of the present disclosure. Terminal 200 includes, for example, reception section 201, transmission section 202, and control section 203. Terminal 200 communicates with, for example, base station 100 (see FIG. 10) by radio. Note that, reception section 201 and transmission section 202 may be collectively referred to as a communication section.

Reception section 201 receives a DL signal transmitted from base station 100. For example, under the control of control section 203, reception section 201 receives a DL signal.

For example, reception section 201 receives various control signals, reference signals, data signals, and the like from base station 100 as DL signals. Reception section 201 receives, for example, various signals, channels, configuration information, control information, and the like described in the above embodiment as DL signals from base station 100.

For example, reception section 201 receives a signal from base station 100.

Transmission section 202 transmits a UL signal to base station 100. For example, transmission section 202 transmits a UL signal under the control of control section 203.

For example, transmission section 202 transmits, as a UL signal, a signal including information on the processing capability of terminal 200, various control signals, reference signals, data signals, and the like to base station 100.

Control section 203 controls the overall (communication) operation of terminal 200, including the reception processing in reception section 201 and the transmission processing in transmission section 202.

For example, control section 203 acquires information such as data and control information from a higher layer and outputs the information to transmission section 202. Further, control section 203 outputs, for example, data and control information received from reception section 201 to a higher layer.

Control section 203 executes operations other than the transmission and reception described in the above embodiment (note that the operations may be executed by reception section 201 and/or transmission section 202).

Note that the signal received by terminal 200 from base station 100 may be a signal directly transmitted from base station 100 or may be a signal transmitted from base station 100 and forwarded by relay apparatus 300. Further, the signal transmitted by terminal 200 to base station 100 may be directly received by base station 100 or may be forwarded by relay apparatus 300 and received by base station 100. In this case, terminal 200 does not need to recognize whether the signal is forwarded by relay apparatus 300.

### Relay Apparatus

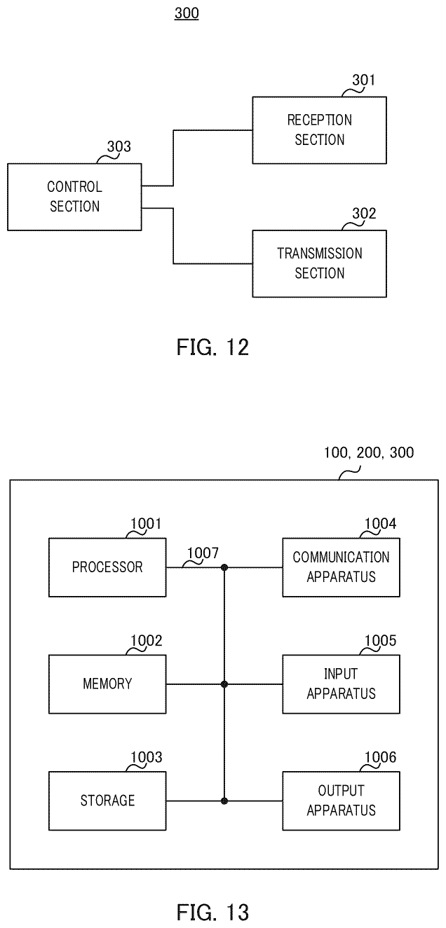

FIG. 12 is a block diagram illustrating an exemplary configuration of relay apparatus 300 according to the embodiment of the present disclosure. Relay apparatus 300 corresponds to an example of an NCR. Relay apparatus 300 includes, for example, reception section 301, transmission section 302, and control section 303. Relay apparatus 300 communicates with, for example, base station 100 (see FIG. 10) and terminal 200 (see FIG. 11) by radio. Note that, reception section 301 and transmission section 302 may be collectively referred to as a communication section.

Reception section 301 receives a DL signal transmitted from base station 100. For example, reception section 301 receives a signal transmitted from base station 100 and addressed to terminal 200 using a beam determined by control section 303. Further, reception section 301 receives a UL signal transmitted from terminal 200. For example, reception section 301 receives a DL signal and a UL signal under the control of control section 303. Note that the received signals may include a signal addressed to base station 100, a signal addressed to terminal 200, and a signal addressed to relay apparatus 300.

For example, reception section 301 receives, from base station 100 via the C-link, RRC control information or configuration information related to beams that can be used by relay apparatus 300 in the backhaul link. For example, reception section 301 receives MAC control information related to a beam to be used by relay apparatus 300 in the backhaul link, from base station 100 via the C-link. The MAC control information may include one or both of beam information related to a DL beam to be used for receiving a signal from base station 100 in the backhaul link or beam information related to a UL beam to be used for transmitting a signal to base station 100 in the backhaul link. In addition, the MAC control information may have the same configuration for the DL beam and the UL beam. The MAC control information may further include indication information for indicating whether the MAC control information includes beam information related to a DL beam or beam information related to a UL beam. In addition, the MAC control information may include indication information for indicating whether the MAC control information includes only the beam information related to the DL beam, only the beam information related to the UL beam, or both the beam information related to the DL beam and the beam information related to the UL beam. The MAC control information may include one field for indicating that the beam information related to the DL beam and the beam information related to the UL beam are the same. In addition, for example, reception section 301 receives, from base station 100 via the C-link, RRC control information or configuration information related to the case of joint DL/UL TCI or the case of separate DL/UL TCI, and RRC control information or configuration information related to the case of a Rel-15 beam indication framework or the case of a Rel-17 beam indication framework.

Transmission section 302 transmits a UL signal received from terminal 200 and addressed to base station 100, to base station 100 using the beam determined by control section 303. Further, transmission section 302 transmits a DL signal received from base station 100 and addressed to terminal 200, to terminal 200. For example, transmission section 302 transmits the UL signal under the control of control section 303.

Control section 303 controls the overall (communication) operation of relay apparatus 300, including the reception processing in reception section 301 and the transmission processing in transmission section 302.

For example, control section 303 acquires information such as data and control information from a higher layer and outputs the information to transmission section 302. Further, control section 303 outputs, for example, data and control information received from reception section 301 to a higher layer.

Control section 303 executes operations other than the transmission and reception described in the above embodiment (note that the operations may be executed by reception section 301 and/or transmission section 302).

For example, control section 303 determines a beam to be used by relay apparatus 300 from the configured beams that can be used by relay apparatus 300 in the backhaul link, based on the MAC control information.

Furthermore, FIG. 12 illustrates a configuration in which one reception section 301, one transmission section 302, and one control section 303 are included, but the present disclosure is not limited thereto. For example, as described above, because relay apparatus 300 (e.g., NCR 300) includes two functional entities of an NCR-MT that performs communication in the C-link and an NCR-Fwd that performs communication in the access link and the backhaul link, relay apparatus 300 may include a reception section, a transmission section, and a control section for each of the NCR-MT and the NCR-Fwd. Alternatively, relay apparatus 300 may include a reception section, a transmission section, and a control section for communication of each of the C-link, the access link, and the backhaul link.

Note that relay apparatus 300 (e.g., NCR) in the present disclosure may be an example of a communication apparatus. Further, relay apparatus 300 in the present disclosure may be referred to by another name such as a forwarding apparatus or a relay device. Further, relay apparatus 300 in the present disclosure may be replaced with terminal 200 (e.g., UE). For example, relay apparatus 300 may be regarded as terminal 200 having a forwarding function (or a relay function).

### Summary of Embodiment

According to an embodiment of the present disclosure, a relay apparatus is provided, which includes: a reception section that receives, from a base station, control information related to a beam to be used by the relay apparatus in a communication link for relaying, between the base station and the relay apparatus, communication between the base station and a terminal; and a control section that determines the beam to be used by the relay apparatus, based on the control information, in which the control information includes one or both of first beam information related to a first beam to be used for receiving a signal from the base station in the communication link, and second beam information related to a second beam to be used for transmitting a signal to the base station in the communication link.

With the above configuration, one or both of the first beam (DL beam) used for receiving a signal from the base station in the communication link and the second beam (UL beam) used for transmitting a signal to the base station in the communication link can be determined based on the control information, and thus the communication between the base station and the terminal can be appropriately relayed.

In the present relay apparatus, a configuration of the control information for the first beam and a configuration of the control information for the second beam are the same.

The above configuration can eliminate or reduce a necessity of signaling related to additional beam indication.

In the present relay apparatus, the control information further includes indication information indicating whether the control information includes the first beam information or the second beam information, in a case where the control information includes either the first beam information or the second beam information.

The above configuration can eliminate or reduce a necessity of signaling related to additional beam indication.

In the present relay apparatus, the control information further includes indication information indicating whether the control information includes only the first beam information, only the second beam information, or both the first beam information and the second beam information.

The above configuration can eliminate or reduce a necessity of signaling related to additional beam indication.

In the present relay apparatus, the control information includes, in a case where the control information includes both the first beam information and the second beam information, a field indicating that the first beam information and the second beam information are the same.

The above configuration can eliminate or reduce a necessity of signaling related to additional beam indication. Furthermore, since the indication of the DL beam and the indication of the UL beam are performed using one field, efficient beam control can be performed.

According to an embodiment of the present disclosure, a communication control method is provided, which includes: receiving, by a relay apparatus, from a base station, control information related to a beam to be used by the relay apparatus in a communication link for relaying, between the base station and the relay apparatus, communication between the base station and a terminal; and determining, by the relay apparatus, the beam to be used by the relay apparatus, based on the control information, in which the control information includes one or both of first beam information related to a first beam to be used for receiving a signal from the base station in the communication link, and second beam information related to a second beam to be used for transmitting a signal to the base station in the communication link..

With the above configuration, one or both of the first beam (DL beam) used for receiving a signal from the base station in the communication link and the second beam (UL beam) used for transmitting a signal to the base station in the communication link can be determined based on the control information, and thus the communication between the base station and the terminal can be appropriately relayed.

The present disclosure has been described thus far. It should be noted that the classification of items in the above description is not essential for the present disclosure, and the matters described in two or more items may be used in combination as necessary, or a matter described in a certain item may be applied to a matter described in another item (unless inconsistency occurs).

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (e.g., via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

For example, a base station, a terminal, a relay apparatus (e.g., NCR), and so on according to one embodiment of the present disclosure may function as a computer that executes the processes of the radio communication method of the present disclosure. FIG. 13 is a diagram to show an example of a hardware structure of a base station, a terminal, and a relay apparatus according to an embodiment of the present disclosure. Physically, the above-described base station 100 and terminal 200, and relay apparatus 300 may each be formed as a computer apparatus that includes processor 1001, memory 1002, storage 1003, communication apparatus 1004, input apparatus 1005, output apparatus 1006, bus 1007, and so on.

Note that in the present disclosure, the words such as an apparatus, a circuit, a device, a section, a unit, and so on can be interchangeably interpreted. The hardware structure of base station 100, terminal 200, and relay apparatus 300 may be configured to include one or more of apparatuses shown in the drawings, or may be configured not to include part of apparatuses.

Each function of base station 100, terminals 200, and relay apparatus 300 is implemented, for example, by allowing certain software (programs) to be read on hardware such as processor 1001 and memory 1002, and by allowing processor 1001 to perform calculations to control communication via communication apparatus 1004 and control at least one of reading and writing of data in memory 1002 and storage 1003.

Processor 1001 controls the whole computer by, for example, running an operating system. Processor 1001 may be configured with a central processing unit (CPU), which includes interfaces with peripheral apparatus, control apparatus, computing apparatus, a register, and so on. For example, at least part of above-described control section 103, control section 203, control section 303, and so on may be implemented by processor 1001.

Furthermore, processor 1001 reads programs (program codes), software modules, data, and so on from at least one of storage 1003 and communication apparatus 1004, into memory 1002, and executes various processes according to these. As for the programs, programs to allow computers to execute at least part of the operations of the above-described embodiments are used. For example, base station 100, terminal 200, and relay apparatus 300 may be implemented by control programs that are stored in memory 1002 and that operate on processor 1001, and other functional blocks may be implemented likewise. The various processes have been described to be performed by single processor 1001. However, the processes may be performed by two or more processors 1001 simultaneously or sequentially. Processor 1001 may be implemented by one or more chips. It should be noted that the program may be transmitted from a network via a telecommunication line.

Memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. Memory 1002 may be referred to as a “register,” a “cache,” a “main memory (primary storage apparatus)” and so on. Memory 1002 can store executable programs (program codes), software modules, and the like for implementing the radio communication method according to one embodiment of the present disclosure.

Storage 1003 is a computer-readable recording medium, and may be constituted with, for example, at least one of a flexible disk, a floppy (registered trademark) disk, a magneto-optical disk (e.g., a compact disc (Compact Disc ROM (CD-ROM) and so on), a digital versatile disc, a Blu-ray (registered trademark) disk), a removable disk, a hard disk drive, a smart card, a flash memory device (e.g., a card, a stick, and a key drive), a magnetic stripe, a database, a server, and other appropriate storage media. Storage 1003 may be referred to as “auxiliary storage apparatus.” The above recording medium may be a database including memory 1002 and/or storage 1003, a server, or any other appropriate medium.

Communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. Communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmission section 101, transmission section 202, transmission section 302, reception section 102, reception section 201, reception section 301, and the like may be realized by communication apparatus 1004. Communication apparatus 1004 may be implemented by physically or logically divided into a transmission section and reception section.

Input apparatus 1005 is an input device that receives input from the outside (e.g., a keyboard, a mouse, a microphone, a switch, a button, a sensor, and so on). Output apparatus 1006 is an output device that allows sending output to the outside (e.g., a display, a speaker, a Light Emitting Diode (LED) lamp, and so on). Note that input apparatus 1005 and output apparatus 1006 may be provided in an integrated structure (e.g., a touch panel).

Furthermore, these types of apparatus, including processor 1001, memory 1002, and others, are connected by bus 1007 for communicating information. Bus 1007 may be formed with a single bus, or may be formed with buses that vary between pieces of apparatus.

Also, base station 100, terminals 200, and relay apparatus 300 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Supplement to Embodiment

While the embodiment of the present disclosure has been described above, the disclosed invention is not limited to such an embodiment, and a person skilled in the art would understand various variations, modifications, alternatives, substitutions, and the like. Specific numerical examples have been used in the description to facilitate understanding of the invention, but unless otherwise noted, these numbers are merely examples and any suitable values may be used. The division of the items in the above description is not essential to the present disclosure, and matters described in two or more items may be combined and used as necessary, and matters described in one item may be applied to matters described in another item (as long as they do not contradict each other). The boundaries of the functional sections and processing sections in the functional block diagram do not necessarily correspond to the boundaries of physical components. The operations of a plurality of functional sections may be performed physically by one component, or the operation of one functional section may be performed physically by a plurality of components. The processing procedures described in the embodiment may be performed in a different order as long as there is no contradiction. For convenience of description of the processing, base station 100, terminal 200, and relay apparatus 300 have been described using functional block diagrams, but such apparatuses may be implemented in hardware, software, or a combination thereof. Software that operates on a processor included in base station 100 according to an embodiment of the present disclosure, software that operates on a processor included in terminal 200 according to an embodiment of the present disclosure, and software that operates on a processor included in relay apparatus 300 according to an embodiment of the present disclosure may each be stored in any suitable storage medium, such as a random access memory (RAM), a flash memory, a read-only memory (ROM), an erasable programmable read-only memory (EPROM), an electrically erasable programmable read-only memory (EEPROM), a register, a hard disk (HDD), a removable disk, a CD-ROM, a database, a server, or the like.

### Notification and Signaling of Information

Notification of information is by no means limited to the embodiments described in the present disclosure, and other methods may be used as well. For example, notification of information in the present disclosure may be implemented by using physical layer signaling (e.g., downlink control information (DCI), uplink control information (UCI)), higher layer signaling (e.g., Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

### Application System

The embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG (where x is, e.g., an integer or a decimal)), Future Radio Access (FRA), New Radio (NR), New radio access (NX), Future generation radio access (FX), W-CDMA (registered trademark), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (e.g., a combination of LTE or LTE-A and 5G, and the like) for application.

### Processing Procedure and the Like

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

### Operation of Base Station

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (e.g., Mobility Management Entities (MMEs), Serving-Gateways (S-GWs), and so on may be possible, but these are not limiting) other than base stations, or combinations of these. According to the above, a case is described in which there is a single network node other than the base station. However, a combination of multiple other network nodes may be considered (e.g., MME and S-GW).

### Direction of Input and Output

The information or signals described in this disclosure may be output from a higher layer (or lower layer) to a lower layer (or higher layer). The information or signals may be input or output through multiple network nodes.

### Handling of Input and Output Information and the Like

The input or output information may be stored in a specific location (e.g., memory) or managed using management tables. The input or output information may be overwritten, updated, or added. The information that has been output may be deleted. The information that has been input may be transmitted to another apparatus.

### Determination Method

A decision or a determination in an embodiment of the present invention may be realized by a value (0 or 1) represented by one bit, by a boolean value (true or false), or by comparison of numerical values (e.g., comparison with a predetermined values).

### Variations and the like of Aspects

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### Software

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

### Information and Signals

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

### System and Network

As used in the present disclosure, the terms “system” and “network” are used interchangeably.

### Names of Parameters and Channels

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

### Base Station

In the present disclosure, the terms such as a “base station (BS),” a “radio base station,” a “fixed station,” a “NodeB,” an “eNB (eNodeB),” a “gNB (gNodeB),” an “access point,” a “transmission point,” a “reception point,” a “transmission/reception point,” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (e.g., three) cells. When a base station accommodates a plurality of cells, the entire coverage area of the base station can be partitioned into multiple smaller areas, and each smaller area can provide communication services through base station subsystems (e.g., indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

### Mobile Station

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

### Base Station/Mobile Station

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving. The moving object may be a vehicle (e.g., a car, an airplane, and the like), may be a moving object which moves unmanned (e.g., a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, the base station in the present disclosure may be interpreted as a terminal. For example, an embodiment of the present disclosure may be applied to the structure that replaces a communication between a base station and a terminal with a communication between a plurality of terminals (e.g., which may be referred to as “Device-to-Device (D2D),”“Vehicle-to-Everything (V2X),” and the like). In this case, terminal 200 may have the functions of base station 100 described above. The words such as “uplink” and “downlink” may be interpreted as the words corresponding to the terminal-to-terminal communication (e.g., “sidelink”). For example, an uplink channel, a downlink channel and so on may be interpreted as a sidelink channel.

Likewise, the terminal in the present disclosure may be interpreted as base station. In this case, base station 100 may have the functions of terminal 200 described above.

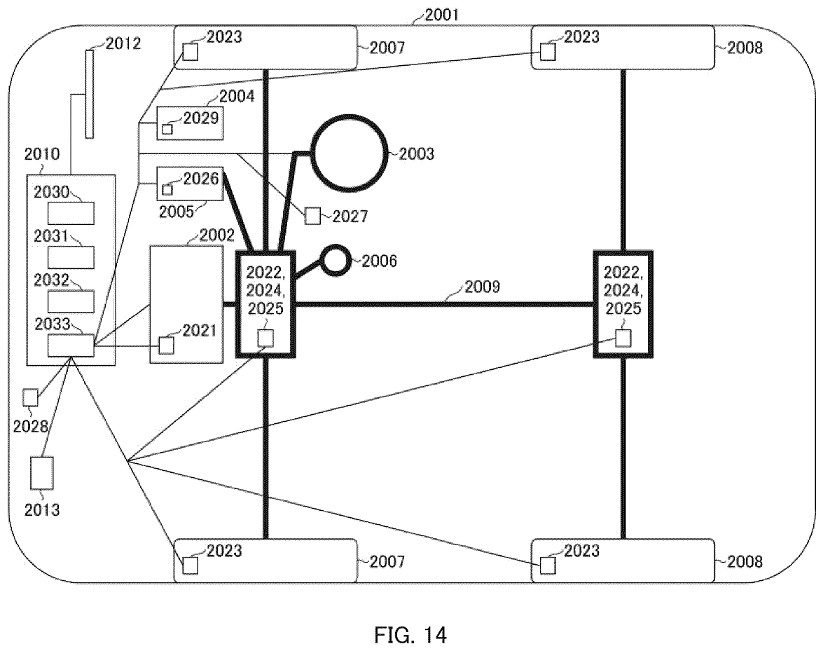

FIG. 14 shows an example of a configuration of vehicle 2001. As shown in FIG. 14, vehicle 2001 includes drive unit 2002, steering unit 2003, accelerator pedal 2004, brake pedal 2005, shift lever 2006, front wheel 2007, rear wheel 2008, axle 2009, electronic control unit 2010, various sensors 2021 to 2029, information service unit 2012, and communication module 2013. The aspects/embodiments described in the present disclosure may be applied to a communication device mounted in vehicle 2001, and may be applied to, for example, communication module 2013.

Drive unit 2002 may include, for example, an engine, a motor, and a hybrid of an engine and a motor. Steering unit 2003 includes at least a steering wheel and is configured to steer at least one of the front wheel or the rear wheel, based on the operation of the steering wheel operated by the user.

Electronic control unit 2010 includes microprocessor 2031, memory (ROM, RAM) 2032, and communication port (IO port) 2033. Electronic control unit 2010 receives signals from the various sensors 2021 to 2029 provided in vehicle 2001. Electronic control unit 2010 may be referred to as an ECU (Electronic control unit).

Signals from various sensors 2021 to 2029 include a current signal from current sensor 2021 which senses the current of the motor, a front or rear wheel rotation signal acquired by revolution sensor 2022, a front or rear wheel pneumatic signal acquired by pneumatic sensor 2023, a vehicle speed signal acquired by vehicle speed sensor 2024, an acceleration signal acquired by acceleration sensor 2025, a stepped-on accelerator pedal signal acquired by accelerator pedal sensor 2029, a stepped-on brake pedal signal acquired by brake pedal sensor 2026, an operation signal of a shift lever acquired by shift lever sensor 2027, and a detection signal, acquired by object detection sensor 2028, for detecting an obstacle, a vehicle, a pedestrian, and the like.

Information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

Information service unit 2012 may include an input device (e.g., a keyboard, a mouse, a microphone, a switch, a button, a sensor, a touch panel, and the like) for receiving input from the outside, or may include an output device (e.g., a display, a speaker, an LED lamp, a touch panel, and the like) for implementing output to the outside.

Driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, driving support system unit 2030 transmits and receives various types of information via communication module 2013 to realize a driving support function or an autonomous driving function.

Communication module 2013 may communicate with microprocessor 2031 and components of vehicle 2001 via a communication port. For example, communication module 2013 transmits and receives data via communication port 2033, to and from drive unit 2002, steering unit 2003, accelerator pedal 2004, brake pedal 2005, shift lever 2006, front wheel 2007, rear wheel 2008, axle 2009, microprocessor 2031 and memory (ROM, RAM) 2032 in electronic control unit 2010, and sensors 2021 to 2029 provided in vehicle 2001.

Communication module 2013 is a communication device that can be controlled by microprocessor 2031 of electronic control unit 2010 and that is capable of communicating with external devices. For example, various kinds of information are transmitted to and received from external devices through radio communication. Communication module 2013 may be internal to or external to electronic control unit 2010. The external devices may include, for example, a base station, a mobile station, or the like.

Communication module 2013 may transmit at least one of signals from various sensors 2021 to 2029 described above input to electronic control unit 2010, information obtained based on the signals, and information based on an input from the outside (a user) obtained via information service unit 2012, to the external apparatus via radio communication. Electronic control unit 2010, various sensors 2021 to 2029, information service unit 2012, and the like may be referred to as input units that receive input. For example, the PUSCH transmitted by communication module 2013 may include information based on the input.

Communication module 2013 receives various types of information (traffic information, signal information, inter-vehicle information, etc.) transmitted from the external devices and displays the received information on information service unit 2012 provided in vehicle 2001. Information service unit 2012 may be referred to as an output unit that outputs information (e.g., outputs information to devices, such as a display and a speaker, based on the PDSCH received by communication module 2013 (or data/information decoded from the PDSCH)). In addition, communication module 2013 stores the various types of information received from the external devices in memory 2032 available to microprocessor 2031. Based on the information stored in memory 2032, microprocessor 2031 may control drive unit 2002, steering unit 2003, accelerator pedal 2004, brake pedal 2005, shift lever 2006, front wheel 2007, rear wheel 2008, axle 2009, and sensors 2021 to 2029 mounted in vehicle 2001.

### Meaning and Interpretation of Terms

As used herein, the term “determining” may encompass a wide variety of actions. For example, “determining” may be regarded as judging, calculating, computing, processing, deriving, investigating, looking up or search inquiry (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing, and the like. That is, “determining” may be regarded as a certain type of action related to determining. Also, “determining” may be replaced with “assuming,” “expecting,” “considering,” and the like.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access.” As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

### Reference Signal

A reference signal may be abbreviated as an “RS,” and may be referred to as a “pilot” and so on, depending on which standard applies.

### Meaning of “Based On”

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

### “First” and “Second”

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

### Means

“Means” included in the configuration of each of the above apparatuses may be replaced by “parts,” “circuits,” “devices,” etc.

### Open Form

In the case where the terms “include,” “including” and variations thereof are used in the present disclosure, these terms are intended to be comprehensive in the same way as the term “comprising.” Further, the term “or” used in the present specification is not intended to be an “exclusive or.”

### Time Units such as TTI, Frequency Units such as RB, and Radio Frame Configuration

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (e.g., 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “Transmission Time Interval (TTI),” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (e.g., 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (e.g., the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in LTE Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (e.g., a normal TTI, a subframe, or the like) may be interpreted as a TTI having a time length exceeding 1 ms, and a short TTI (e.g., a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP.”

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

### Maximum Transmit Power

The “maximum transmit power” described in the present disclosure may mean a maximum value of the transmit power, the nominal UE maximum transmit power, or the rated UE maximum transmit power.

### Article

In the present disclosure, where an article is added by translation, for example “a,” “an,” and “the,” the disclosure may include that the noun following these articles is plural.

### “Different”

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different.”

### INDUSTRIAL APPLICABILITY

An aspect of the present disclosure is useful for radio communication systems.

### REFERENCE SIGNS LIST

10 Radio communication system
20 NG-RAN
100 Base station (gNB)
200 Terminal (UE)
300 Relay apparatus (NCR)
101, 202, 302 Transmission section
102, 201, 301 Reception section
103, 203, 303 Control section
1001 Processor
1002 Memory
1003 Storage
1004 Communication apparatus
1005 Input apparatus
1006 Output apparatus
1007 Bus

1. A relay apparatus, comprising:
a reception section that receives, from a base station, control information related to a beam to be used by the relay apparatus in a communication link for relaying, between the base station and the relay apparatus, communication between the base station and a terminal; and
a control section that determines the beam to be used by the relay apparatus, based on the control information, wherein
the control information includes one or both of first beam information related to a first beam to be used for receiving a signal from the base station in the communication link, and second beam information related to a second beam to be used for transmitting a signal to the base station in the communication link.

2. The relay apparatus according to claim 1, wherein
a configuration of the control information for the first beam and a configuration of the control information for the second beam are the same.

3. The relay apparatus according to claim 2, wherein
the control information further includes indication information indicating whether the control information includes the first beam information or the second beam information, in a case where the control information includes either the first beam information or the second beam information.

4. The relay apparatus according to claim 2, wherein
the control information further includes indication information indicating whether the control information includes only the first beam information, only the second beam information, or both the first beam information and the second beam information.

5. The relay apparatus according to claim 2, wherein
the control information includes, in a case where the control information includes both the first beam information and the second beam information, a field indicating that the first beam information and the second beam information are the same.

6. A communication control method, comprising:
receiving, by a relay apparatus, from a base station, control information related to a beam to be used by the relay apparatus in a communication link for relaying, between the base station and the relay apparatus, communication between the base station and a terminal; and
determining, by the relay apparatus, the beam to be used by the relay apparatus, based on the control information, wherein
the control information includes one or both of first beam information related to a first beam to be used for receiving a signal from the base station in the communication link, and second beam information related to a second beam to be used for transmitting a signal to the base station in the communication link.
